(19) United States
(12) Patent Application Publication
(10) Pub. No.: US 2013/0151664 A1
(43) Pub. Date: Jun. 13, 2013

(54) DATA TRANSFER SYSTEM

(71) Applicant: Yasuhiro Miyao, Tokyo (JP)

(72) Inventor: Yasuhiro Miyao, Tokyo (JP)

(73) Assignee: NEC CORPORATION, Tokyo (JP)

(21) Appl. No.: 13/818,147

(22) PCT Filed: Aug. 23, 2011
(86) PCT No.: PCT/JP2011/004665

§ 371 Date: Feb. 21, 2013

(30) Foreign Application Priority Data
Sep. 2, 2010 (JP) 2010-196416

(51) Int. Cl. H04L 12/26

(52) U.S. Cl. CPC H04L 43/0876
USPC 709/217

(57) ABSTRACT

The domain resolution server includes measurement means for measuring communication states between sites, path setting means for setting a path for delivering content based on the measurement result, and assignment means for assigning a proxy server corresponding to a domain. The path setting means sets, on the path, a domain resolution server of an adjacent parent site located upstream of the own site as a parent domain resolution server. The assignment means requests the parent domain resolution server for domain resolution based on an identifier, and in accordance with a response, notifies a proxy server of the own site of a proxy server in the parent site to which a content request should be transferred, assigns a proxy server to be required from among the proxy servers in the own site in response to a request from a client or a domain resolution server of a child site, and notifies.

### TECHNICAL FIELD

The present invention relates to a data transfer system, and in particular, to a system for transferring data between computers disposed distributedly on a network.

### BACKGROUND ART

In the Internet, data is transferred between sites which are distributedly arranged geographically. Along with the spread of computers and the development of network technology in recent years, the quantity of transferred data, to be transmitted and received between sites, is increasing. As such, it is desirable that data can be transferred at a high-speed even if the quantity of transferred data increases.

Here, a data transfer system as shown in FIG. 1 will be considered. The data transfer system as shown in FIG. 1 includes client devices 41 to 44 and a distribution system 22. The distribution system 22 is adapted to provide various services such as posting and delivery of content to the client devices 41 to 44, and is configured of a plurality of sites 101 to 104 and a subnetwork 18 linking them.

It should be noted that each of the sites 101 to 104 indicates, as shown by a reference numeral 102 in FIG. 2 for example, a location where one or more server devices (OGS 202, DRS 302, and PSs 503, 504, and 505) capable of processing or storing data are disposed. The server devices are linked with an edge router 20 located for accessing the Internet, via a multilayer switch 19.

A specific method for identifying such a site may be a city or a country. Further, the site installation type ranges from a small one in which server devices are stored in racks and installed on a floor of a building to an internet data center (iDC) dedicated for accommodating an enormous number of server devices.

Some specific examples, in which high-speed data transfer is required between sites, are found in a CDN (Contents Delivery Network) as disclosed in Patent Document 2. First, in the CDN, there is a case of replicating data from a web site issued by a content holder or a site where content data such as moving images is hosted (referred to as an origin site) to an edge site which delivers the data to an end user. In another example in the CDN, if desired valid content is not cached in the edge site accessed by a content user, there is a case of transferring content data from the origin site to the edge site. In still another example, there is a case of transferring non-cacheable data, to be generated dynamically in an origin site, from the origin site to the edge site accessed by an end user. In all of these examples, if data can be transferred at a high speed from the origin site to the edge site, the feeing and the satisfaction of the end user can be improved.

On the other hand, while caching is effectively used for content having high access frequency in the above-described CDN, if there are a large number of pieces of content having extremely low access frequency such as a long tail, caching is not effective any more. As such, in an edge site where a user first accesses such content, it is often necessary to access the origin site to obtain the content data.

Accordingly, in order to improve the user's feeling, it is necessary to transfer data at a high speed from the origin site to the edge site.

Patent Document 1 discloses a method for increasing throughput by using a multihop path at an application level, in which a relay site is set between an origin site, holding content, and an edge site which is an access destination of a client. In this example, a selection candidate which is a 2-hop path is determined based on the measurement of, for example, a round trip time (hereinafter abbreviated as RTT) which is a delay caused in a round trip of packets between transmission and reception, and an optimum path is selected from among them and a direct path based on tentative download of data.

Non-Patent Document 1 discloses a technique of improving throughput by segmenting content data to be acquired and transferring the segmented data in parallel. In this example, when a client requests a file, the request it divided into blocks at the entrance site and an HTTP request, including newly assigned URI, is transferred to a previously allocated exist site. Then, from the exit site, an HTTP request, having a range header with respect to the original URI, is transferred to the origin site. In this way, the respective blocks are transferred as HTTP responses in parallel to the entrance site on the path passing a plurality of exit sites, assembled at the entrance site, and transferred to the client. It should be noted that in the following description, HTTP requests and HTTP responses indicate those related to the GET method unless otherwise noted.

Non-Patent Document 2 discloses a method of determining a spanning distribution tree linking respective sites in a manner that the bottleneck band of an overlay path between sites becomes maximum. Unlike Patent Document 1 and Non-Patent Document 1, as there is no limitation in the number of hops, throughput can be improved accordingly.

Non-Patent Document 3 discloses that in an overlay network on the Internet, a point-to-point overlay path linking from an overlay node to another overlay node is set dynamically based on the measurement of the performance between the respective overlay nodes.

Non-Patent Document 4 discloses that respective segmented blocks are put into substreams in units of the same modulo, and in units of part (consisting of a plurality of blocks) of each substream, they are received from different peers and assembled once, and another part of the substream is provided to another peer. Thereby, it is realized that a streaming service is provided to an enormous number of peers simultaneously.

All of the above-described techniques aim to increase the throughput of the application level by overlaying a network of the application level on the Internet.

It should be noted that between sites constituting an overlay network of the application level, a TCP connection is terminated in order to transfer application data. To control the throughput of the application level, the property of the TCP must be known. Hereinafter, a TCP connection which is set for transferring HTTP data among a client, a proxy server, and an origin server is called an HTTP connection.

In order to transferring data of an application such as HTTP (HyperText Transfer Protocol) without any error between end systems such as server devices or PCs of end users, TCP (Transmission Control Protocol) is used. TCP is for receiving data without any error by receiving and processing a response of reception confirmation with respect to transmitted data.

As disclosed in Non-Patent Document 5, the throughput depends on the RTT and the packet loss rate. The RTT includes a propagation delay in a round trip between transmission and reception, a protocol processing delay of packets in the device in a round trip, a transfer relay to the network, and the like. It should be noted that in a round trip between transmission and reception, it is not always the case that the same path is passed outward and inward.

Generally, between transmission and reception, as the number of hops on the Internet increases, the packet loss rate increases. In particular, in the case of including a link between ASs by a submarine cable linking different continents or islands, the RTT will be large due to the transmission delay. As such, the throughput at the time of data transfer by the TCP is lowered.

Further, in the flow control of the TCP, the window size for determining the upper limit of the quantity of data which can be transmitted sequentially without any reception response is changed dynamically according to the way that a reception response returns. This control is based on the Additive increase multiplicative decrease rule. As such, if it is determined that there is a packet loss, the window size of that time is decreased by half, thereby the quantity of data to be transferred is decreased by half.

Accordingly, as disclosed in Non-Patent Document 6, there are two approaches to increase the throughput at the application level, in consideration of such characteristics of the TCP. One approach is to reduce the RTT in the relay device at the application level. Assuming that a maximum window size is W, and RTT at a link e is Tₑ, throughput at the link is W/Tₑ, whereby the throughput at a path h is a minimum value among the throughputs at respective links. As such, if a set of links included in the path h is Eₕ, the throughput can be calculated by min_{eεEₕ}W/Tₑ. As such, the throughput can be maximized by selecting a path such that the maximum Tₑ at the path becomes a minimum.

Another approach is to set TCP connections in parallel between adjacent sites. Assuming that the number of connections is Z, the throughput is Z*W/Tₑ. Further, when one packet loss is detected, if the maximum window size is Z times in the solely set TCP connection, the window size is reduce to Z*W/2. However, if Z pieces of TCP connections are set in parallel, as a packet loss is detected in only one connection, the total maximum window size is W/2+(Z−1)*W, so that the difference is (Z−1)*W/2. Accordingly, it is expected that as the number of connections Z set in parallel is larger, the throughput becomes larger.
[Patent Document 1] C. Bornstein, T. Canfiled, G Miller, S. B. Rao, and R. Sundaram, “Optimal route selection in a content delivery network,” U.S. Pat. No. 7,274,658, Sep. 25, 2007.
[Patent Document 2] F. Thomson Leighton and Daniel M. Lewin, “Global hosting system,” U.S. Pat. No. 6,108,703, Aug. 22, 2000.
[Patent Document 3] D. Karger, E. Lehman, F. T. Leighton, M. Levine, D. Lewin, and R. Panigrahy, “Method and apparatus for distributing requests among a plurality of resources,” U.S. Pat. No. 7,127,513, Oct. 24, 2006.
[Non-Patent Document 1] K. Park and V. S. Pai, “Scale and performance in the CoBlitz large-file distribution service,” NSDI' 06.
[Non-Patent Document 2] G. Kwon and J. W. Byers, “ROMA: Reliable overlay multicast with loosely coupled TCP connections,” IEEE INFOCOM 2004.
[Non-Patent Document 3] D. Anderson, H. Balakrishnan, F. Kaashoek, and R. Morris, “Resilient overlay networks,” in Proc. 18th ACM SOSP, October 2001.
[Non-Patent Document 4] B. Li, S. Xie, Y. Qu, G. Keung, C. Lin, J. Liu, and X. Zhang, “Inside the new coolstreaming: principles, measurements and performance implications,” IEEE INFOCOM' 08.
[Non-Patent Document 5] J. Padhye, V. Firoiu, D. Towsley, and J. Kurose, “Modeling TCP throughput: A simple model and its empirical validation,” ACM SIGCOMM Computer Communication Review, vol. 28 no. 4, pp. 303-314, October 1998.
[Non-Patent Document 6] Y. Liu, Y. Gu, H. Zhang, W. Gong, and D. Towsley, “Application level relay for high bandwidth data transport,” GridNet 2004.
[Non-Patent Document 7] http://en.wikipedia.org/wiki/Representational_State_Transfer
[Non-Patent Document 8] http://en.wikipedia.org/wiki/Squid_(software)
[Non-Patent Document 9] R. Cohen and G Kaempfer, “A unicast based approach for streaming multicast”, IEEE INFOCOM 2001.
[Non-Patent Document 10] Y. Miyao, “An optimal design scheme for global overlay networks with enhanced data transfer throughput,” ICC2010.
[Non-Patent Document 11] D. G Thaler, and C. V. Ravishankar, “Using name-based mappings to increase hit rates,” IEEE/ACM Transactions on Networking vol. 6, No. 1, pp. 1-14, February 1998.
[Non-Patent Document 12] HTTP1.1, IETF RFC2616, June, 1999. http://www.w3.org/Protocols/rfc2616/rfc2616.html
[Non-Patent Document 13] http://en.wikipedia.org/wiki/Ajax_programming

### SUMMARY

However, the techniques disclosed in the above-described documents have the following problems. First, Patent Document 1 still involves a problem that throughput between an origin site and an edge site increases, because, as the RTT is measured only from a site which is a candidate of a relay site, only one direction is considered, whereby appropriate control cannot be provided if there are sites between which route asymmetry is large. Further, as only 2 hops at most are considered from the edge server to the origin server, if a larger number of hops are allowed, the RTT between sites can be suppressed so that the throughput is likely to increase.

Further, in Non-Patent Document 2, while the delivery path is optimized (beyond the limitation of 2 hops defined in Patent-Document 1), a specific method of dynamic optimization is not disclosed. Further, in Non-Patent Document 3, while a point-to-point overlay path is set dynamically, the invention does not handle distribution to a plurality of sites. In addition, it is necessary to perform performance measurement for dynamic reconfiguration and acquisition of the statistics in different procedures.

Further, in Patent Document 1, although it is possible to dynamically set a point-to-point path between an edge server and the origin server, it is impossible to set a path for effective distribution from the origin server to a plurality of edge servers. This is because when selecting one path from two path candidates including a direct path to the origin site and a relay site, whether or not data desired for the relay site is cached is not put into consideration.

Further, in Non-Patent Document 4, although throughput can be increased due to parallel partitioned transfer, it does not support a situation of installing a plurality of servers in a site so as to increase the storage capacity, because the invention is based on the premise that files are distributed between clients in a so-called peer-to-peer system.

Further, Non-Patent Document 1 still has a room to increase throughput, because although a relay server is assigned for each of the divided blocks, it is only for the second hop. Further, Non-Patent Document 1 has a problem that as the number of blocks increases, the processing load and the required resources increase. This is because an HTTP connection must be set each time a block is transferred, and the number of message processing for domain resolution increases.

Further, as having been described as the problem of Non-patent Document 4, the technologies other than that of Patent Document 1 are unable to consider an increase in storage capacity due to server clustering within a site.

Accordingly, an object of the present invention is to improve throughput of data transfer between a plurality of server devices disposed distributedly on a network, which is the problem described above.

In order to achieve the object, a data transfer system, which is an aspect of the present invention, is configured such that in a plurality of sites are connected over a network, each of the sites including an origin server in which content is stored, a plurality of proxy servers that transfer requested content, and a domain resolution server that resolves one of the proxy servers corresponding to a domain included in an identifier for requesting data by a client,

the domain resolution server includes a measurement means for measuring each of link parameters representing communication states between respective sites; a path setting means for setting a path for delivering content from the origin server of each of the sites to another one of the sites based on a measurement result; and an assignment means for assigning a proxy server corresponding to the domain.

On the path set for each of the origin servers, the path setting means sets a domain resolution server, disposed in an adjacent parent site located upstream of the own site in which the own domain resolution server is disposed, as a parent domain resolution server with respect to the domain resolution server disposed in the own site, and

the assignment means requests the parent domain resolution server for domain resolution based on the identifier to a proxy server of a data transfer destination, and in accordance with a response from the parent domain resolution server, notifies a proxy server of the own site of a proxy server disposed in the parent site to which a content request should be transferred by the proxy server of the own site, assigns a proxy server to be required from among the proxy servers disposed in the own site in response to a request from the client or a domain resolution server of an adjacent child site located downstream on the path, and notifies the client or the domain resolution server disposed in the child site of the assigned proxy server.

Further, a domain resolution server, which is another aspect of the present invention, is a domain resolution server in a case of a plurality of sites being connected over a network, each of the sites including an origin server in which content is stored, a plurality of proxy servers that transfer requested content, and a domain resolution server that resolves one of the proxy servers corresponding to a domain included in an identifier for requesting data by a client.

The domain resolution server includes a measurement means for measuring each of link parameters representing communication states between respective sites; a path setting means for setting a path for delivering content from the origin server of each of the sites to another one of the sites based on a measurement result; and an assignment means for assigning a proxy server corresponding to the domain.

On the path set for each of the origin servers, the path setting means sets a domain resolution server, disposed in an adjacent parent site located upstream of the own site in which the own domain resolution server is disposed, as a parent domain resolution server with respect to the domain resolution server disposed in the own site, and

the assignment means requests the parent domain resolution server for domain resolution based on the identifier to a proxy server of a data transfer destination, and in accordance with a response from the parent domain resolution server, notifies a proxy server of the own site of a proxy server disposed in the parent site to which a content request should be transferred by the proxy server of the own site, assigns a proxy server to be required from among the proxy servers disposed in the own site in response to a request from the client or a domain resolution server of an adjacent child site located downstream on the path, and notifies the client or the domain resolution server disposed in the child site of the assigned proxy server.

Further, a program, which is another aspect of the present invention, is a program to be installed in a domain resolution server in a case of a plurality of sites being connected over a network, each of the sites including an origin server in which content is accumulated, a plurality of proxy servers that transfer requested content, and the domain resolution server that resolves one of the proxy servers corresponding to a domain included in an identifier for requesting data by a client.

The program realizes, in the domain resolution server, a measurement means for measuring each of link parameters representing communication states between respective sites; a path setting means for setting a path for delivering content from the origin server of each of the sites to another one of the sites based on a measurement result; and an assignment means for assigning a proxy server corresponding to the domain.

On the path set for each of the origin servers, the path setting means sets a domain resolution server, disposed in an adjacent parent site located upstream of the own site in which the own domain resolution server is disposed, as a parent domain resolution server with respect to the domain resolution server disposed in the own site, and

the assignment means requests the parent domain resolution server for domain resolution based on the identifier to a proxy server of a data transfer destination, and in accordance with a response from the parent domain resolution server, notifies a proxy server of the own site of a proxy server disposed in the parent site to which a content request should be transferred by the proxy server of the own site, assigns a proxy server to be required from among the proxy servers disposed in the own site in response to a request from the client or a domain resolution server of an adjacent child site located downstream on the path, and notifies the client or the domain resolution server disposed in the child site of the assigned proxy server.

Further, a data transfer method, which is another aspect of the present invention, is a data transfer method in a data transfer system in which a plurality of sites are connected over a network, each of the sites including an origin server in which content is accumulated, a plurality of proxy servers that transfer requested content, and a domain resolution server that resolves one of the proxy servers corresponding to a domain included in an identifier for requesting data by a client.

The method includes, by the domain resolution server, measuring each of link parameters representing communication states between respective sites, setting a path for delivering content from the origin server of each of the sites to another one of the sites based on a measurement result, and assigning a proxy server corresponding to the domain.

The setting the path includes, on the path set for each of the origin servers, setting a domain resolution server, disposed in an adjacent parent site located upstream of the own site in which the own domain resolution server is disposed, as a parent domain resolution server with respect to the domain resolution server disposed in the own site, and

the assigning includes requesting the parent domain resolution server for domain resolution based on the identifier to a proxy server of a data transfer destination, and in accordance with a response from the parent domain resolution server, notifying a proxy server of the own site of a proxy server disposed in the parent site to which a content request should be transferred by the proxy server of the own site, assigning a proxy server to be required from among the proxy servers disposed in the own site in response to a request from the client or a domain resolution server of an adjacent child site located downstream on the path, and notifying the client or the domain resolution server disposed in the child site of the assigned proxy server.

With the above-described configuration, the present invention is able to improve throughput of data transfer between a plurality of server computers disposed distributedly on a network.

### BRIEF DESCRIPTION OF DRAWINGS

FIG. 1 is a block diagram showing the configuration of the entire data transfer system.

FIG. 2 is a block diagram showing the configuration inside a site according to a first exemplary embodiment.

FIG. 3 is a block diagram showing the configuration of a domain resolution server according to the first exemplary embodiment.

FIG. 4 is an illustration showing a table configuration of a parent DRS storing section according to the first exemplary embodiment.

FIG. 5 is an illustration showing a table configuration of an RTT statistics storing section according to the first exemplary embodiment.

FIG. 6a is a flowchart showing an operation of a parent DRS determination section according to the first exemplary embodiment.

FIG. 6b is a flowchart showing an operation of a parent DRS determination section according to the first exemplary embodiment.

FIG. 7a is a flowchart showing an operation of a PS assignment section according to the first exemplary embodiment.

FIG. 7b is a flowchart showing an operation of a PS assignment section according to the first exemplary embodiment.

FIG. 8 is an illustration of RTT measurement and RTT statistical information acquisition between DRSs according to an example of the first exemplary embodiment.

FIG. 9 is an illustration showing creation of an optimum distribution tree and a table configuration of the parent DRS storing section according to an example of the first exemplary embodiment.

FIG. 10 is an illustration showing a series of operation to transfer a domain resolution request/response message and transfer data of an HTTP request/response, as an example of the first exemplary embodiment.

FIG. 11 is an illustration of an operation to distribute data from the origin site to respective sites, as an example of the first exemplary embodiment.

FIG. 12 is a block diagram showing the configuration of a DRS according to a second exemplary embodiment.

FIG. 13 is a flowchart showing an operation of a distribution tree calculation section of the DRS according to the second exemplary embodiment.

FIG. 14 is a flowchart showing an operation of a PS assignment section of the DRS according to the second exemplary embodiment.

FIG. 15 is an illustration showing a series of operation to transfer a domain resolution/request message and transfer data of an HTTP request/response, as an example of the second exemplary embodiment.

FIG. 16 is a block diagram showing the configuration of an OGS according to a third exemplary embodiment.

FIG. 17a is a flowchart showing an operation of an issuance processing section of the OGS according to the third exemplary embodiment.

FIG. 17b is a flowchart showing an operation of a client processing section of the OGS according to the third exemplary embodiment.

FIG. 18 is an illustration showing a table configuration of a parent PS cache section of a DRS of the third exemplary embodiment.

FIG. 19a is a flowchart showing an operation of a PS assignment section of the DRS according to the third exemplary embodiment.

FIG. 19b is a flowchart showing an operation of the PS assignment section of the DRS according to the third exemplary embodiment.

FIG. 19c is a flowchart showing an operation of the PS assignment section of the DRS according to the third exemplary embodiment.

FIG. 20 is a block diagram showing the configuration of a client according to the third exemplary embodiment.

FIG. 21 is a flowchart showing an operation of a background processing section of the client according to the third exemplary embodiment.

FIG. 22 is an illustration showing a series of operation between a client and an edge site, as an example of the third exemplary embodiment.

FIG. 23 is an illustration showing parallel transfer of a substream on a transfer path from the origin site to a client, according to an example of the third exemplary embodiment.

FIG. 24 is a block diagram showing the configuration of a site according to a fourth exemplary embodiment.

FIG. 25 is a flowchart showing the operation of a PS assignment section of a DRS according to the fourth exemplary embodiment.

FIG. 26 is an illustration showing substream migration, as an example of the fourth exemplary embodiment.

FIG. 27 is a block diagram showing the configuration of a data transfer system according to supplement 1-1 of the present invention.

FIG. 28 is a block diagram showing the configuration of a data transfer system according to supplement 2-1 of the present invention.

### EXEMPLARY EMBODIMENTS

### First Exemplary Embodiment

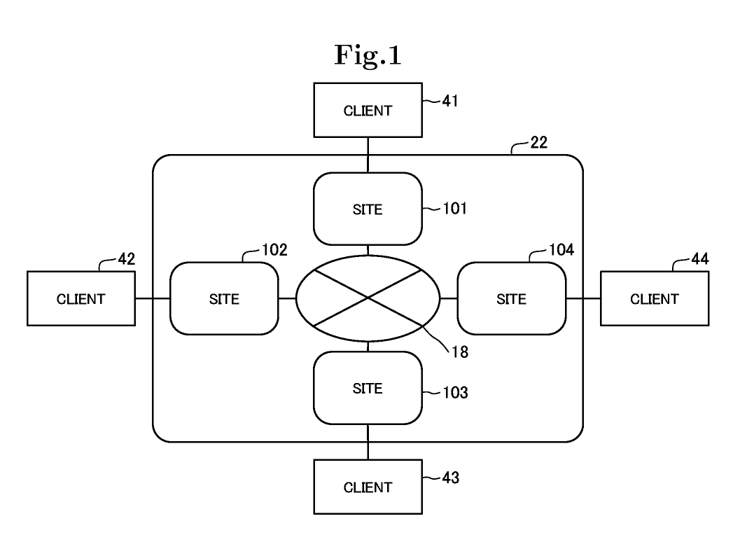

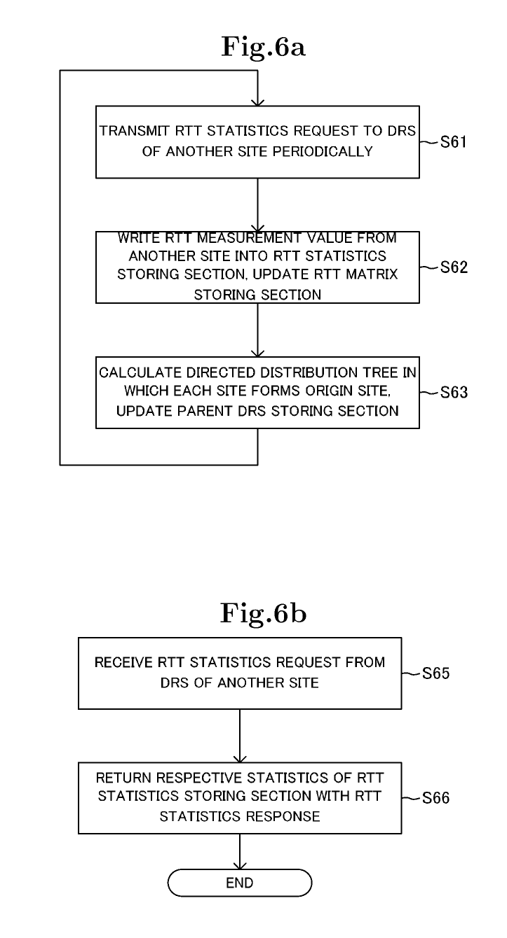

A first exemplary embodiment of the present invention will be described with reference to FIGS. 1 to 11. FIGS. 1 to 5 show the configuration of a data transfer system, and FIGS. 6 to 11 show the operation of the data transfer system.

### [Entire System Configuration]

As shown in FIG. 1, a data transfer system according to the present invention includes clients 41 to 44 and a distribution system 22. The distribution system 22, for providing the clients 41 to 44 with services such as posting and delivery, is configured of a plurality of sites 101 to 104 and a subnetwork 18.

Each of the clients 41 to 44 is an information processing terminal such as a personal computer operated by a particular user, and has a function of uploading or downloading content using HTTP, led by an appropriate site. The clients 41 to 44 transmit and receive content to and from the sites 101 to 104 via a network which is the same as the subnetwork 18 or an independent network.

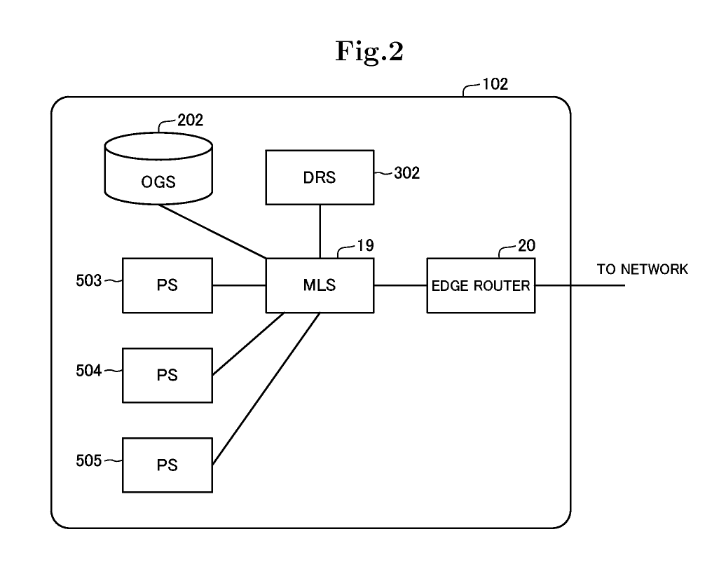

As shown in FIG. 2, the site 102 includes an origin server (OGS) 202, a domain resolution server 302 (DRS), proxy servers (PS) 503 to 505, a multilayer switch (MLS) 19, and an edge router 20.

The origin server (OGS) 202 accepts upload of content. The domain resolution server (DRS) 302 performs address resolution of a proxy server (PS) to which a content data request (HPPT request) is transferred, based on a request from the DRS of another site. The edge router 20 connects respective devices within the site and the subnetwork at the IP level. The MLS 19 connects the OGS 202, the PSs 503 to 505, the DRS 302, and the edge router 20.

As all of the sites 101 to 104 have almost the same configuration, only the site 102 will be described herein. The respective configurations will be described in detail below.

### [Origin Server (OGS)]

First, the origin server 202 (OGS) performs transformation of URI as described in Patent Document 2 in order to assign one of a plurality of PSs in the site of the next hop to different URI, based on the premise of existing clients or proxy servers PS requesting domain resolution of a transfer destination PS for each domain. It should be noted that if a domain resolution request can be made in units of URI, transformation of URI is unnecessary. As such, after storing, in a storing device such as a HDD, content data newly updated from a content issuer, the OGS 202 gives O-URI as shown below to the file:

O-URI--http://www.site1.song.net/videocast/channel3/item2/

Here, the configuration of the O-URI will be described. “song.net” shows the body providing this delivery service, “site1” shows the origin site to which the content is uploaded from the issuer, and “www” shows the host name as the origin server. If the delivery service providing body operates N pieces of sites, the respective sites are indicated as site1, . . . , siteN, for example.

Then, in the path portion of the O-URI, “videocast” shows the name of the content providing service, “channel3” shows an individual channel, and “item2” shows an individual delivery program.

Then, the O-URI is hashed (in this example, the value is 1578), a domain “f1578” is obtained by adding “f” thereto, and www is replaced with the domain to thereby obtain F-URI as shown below:

F-URI: http://f1578.site1.song.net/videocast/channel3/item2/

Here, in order to simplify the description, domains are named as follows:

“O domain”: site1.song.net

A sub-domain corresponding to the origin site. While the details will be described below, by including a domain showing the origin site, it is possible to create a directed distribution tree for each origin site, which has the origin site as a route, so as to be able to transfer a domain resolution request along the path of the distribution tree.

“F domain”: f1578.site1.song.net

A domain name after transformed so as to correspond to different O-URI.

O-URI is used as a link for acquiring data in the portal site. When it is clicked, an HTTP request including the O-URI is transmitted to the origin site, and metadata to be used for acquiring a program file is downloaded from it to the client as an HTTP response. The metadata includes the following information:

O-URI: http://www.site1.song.net/videocast/channel3 and /item2/

Address of edge site DRS: 291.47.234.12, 291.47.234.13

F-URI: http://f1578.site1.song.net/videocast/channel3/item2/

The address of the DRS disposed at the edge site is determined by the origin server as a DRS address of the nearest edge site to which the client should be led, at the timing when the client requests metadata, based on the IP address of the client. In this example, two DRS addresses are described in consideration of a failure in the DRS.

The metadata may be described in XML format. In this way, a web service providing a resource status, in which the URI is designated, in XML format is called RESTful (see Non-Patent Document 7).

It should be noted that even in Patent Document 1, as a cache server is assigned to each content of different URI in the same manner as described above, new URI is created by performing hashing on the original URI so as to assign a virtual server, moving the original URI to the path portion, and adding the domain of the virtual server of Akamai in front of it. On the other hand, the present invention differs from the above-described technique in that not only a site for delivery but also the origin site are operated at the same time by the service operator. As such, it is not necessary to bury the entire original URI into the path portion of the transformed URI.

### [Proxy Server (PS)]

In the proxy servers 503 to 505 (hereinafter abbreviated as PS) used in the present invention, a function of adding functions to the existing one such as that described in Non-Patent Document 8 is restricted to a minimum. Hereinafter, the configuration and operation of the PS will be described.

Each of the proxy servers 503 to 505 caches or stores a block provided from a PS of the parent site to prepare for a request from another site. Here, in adjacent sites on the transfer path of a distribution tree, a site nearer to the route, that is, a site on the upper stream side, is called a parent site, and a site farther from the route, that is, a site on the lower stream side, is called a child site.

When a PS receives an HTTP request, if it stores data of the URI included therein, the PS returns it as an HTTP response. If the PS does not store such data, in order to obtain the address of the PS assigned to the DRS with respect to F domain, the PS makes a domain resolution request, and when it is returned, the PS transfers the HTTP request to the address of the PS. When an HTTP response is returned in reply to the HTTP request, the PS returns the HTTP response to the server which made a request with respect to the URI.

Transfer and accumulation of data by the PS is based on the premise that data of HTTP content is handled on a memory having high-speed input and output. Particularly, in the origin site, data in the HDD in which reading speed is lower than the memory in the OGS is used for transfer after being cached in the PS to thereby improve the performance.

### [Domain Resolution Server (DRS)]

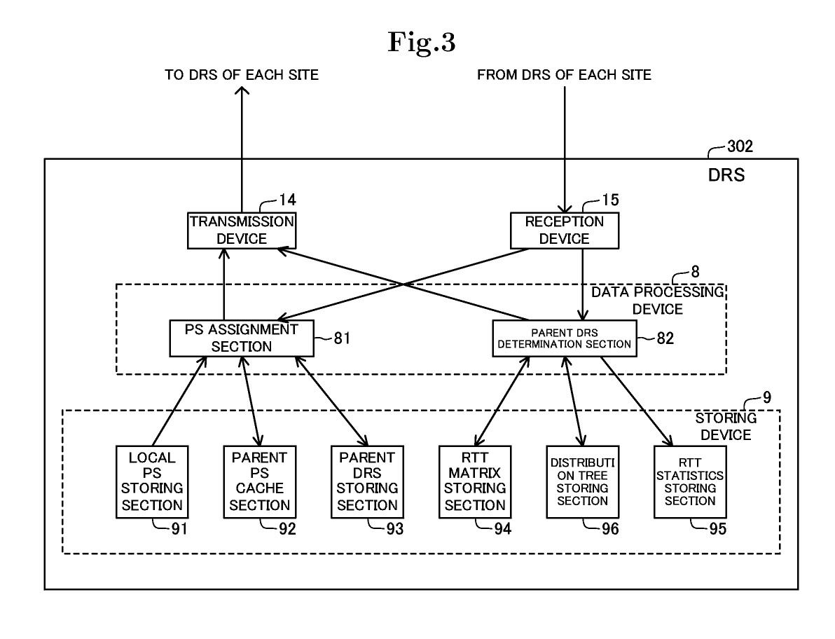

As shown in FIG. 3, the domain resolution server (DRS) 302 includes a transmission device 14, a reception device 15, a data processing device 8, and a storing device 9. The transmission device 14 and the reception device 15 exchange domain resolution request/response messages and RTT statistics request/response messages with DRSs of other sites.

The data processing device 8 includes a PS assignment section 81 and a parent DRS determination section 82, which are constructed by a program installed therein. Here, the “parent DRS” indicates a DRS of a parent site to which a domain resolution request should be transferred next. Further, the “parent site” indicates a site closer to the route, that is, a site of the upper stream side, of two adjacent sites on the transfer path of a directed distribution tree generated as described above.

The parent DRS determination section 82 (measurement means, path setting means) determines the address of the DRS of the parent site to which a domain resolution request should be transmitted. The PS assignment section 81 (assignment means) determines the address of the PS which should be assigned by the own site with respect to each substream, based on a request from the DRS of the child site.

The reception device 15 provides the PS assignment section 81 with a domain resolution response, and provides the parent DRS determination section 82 with an RTT statistics response, respectively. Further, the storing device 9 includes a local PS storing section 91, a parent PS cache section 92, a parent DRS storing section 93, an RTT statistics matrix storing section 94, an RTT statistics processing storing section 95, and a distribution tree storing section 96.

The local PS storing section 91 stores entries consisting of combinations of the PS addresses in the own site, the number of timeouts, and statuses. The parent PS cache section 92 has, as a table, entries including combinations of F domains received as resolution responses from the parent DRS and parent PS addresses.

The parent DRS storing section 93 stores the address of the DRS of the parent site with respect to itself and the status thereof in a directed distribution tree, in which the origin site is the route, calculated by the parent DRS determination section 82. Further, the TTL of the parent DRS storing section 93 shows the remaining time in which this information is valid, and the value becomes smaller as the time elapsed. This table is characterized as to include a transfer destination for domain resolution, rather than a transfer destination of an HTTP request. Further, while a common parent PS is assigned irrespective of the URI in the general system, in the present invention, a parent DRS to be assigned is different depending on the origin site.

The local PS storing section 93 stores addresses of the respective PSs disposed in the local site and the statuses thereof.

The RTT matrix storing section 94 stores, in a matrix, statistics obtained from results of measuring RTTs from a site “i” to a site “j” a predetermined number of times. Here, RTT statistics from another site to the own site is a value copied from the value, which is described in the RTT statistics response received with respect to the RTT statistics response, to the corresponding entry of the RTT matrix storing section 94, and in the case of a value measured from the own site to another site, the value is copied from the minimum value (see FIG. 5) of the RTTs included in the table in the RTT statistics storing section 95 of the own site, to the corresponding entry of the RTT matrix storing section 94.

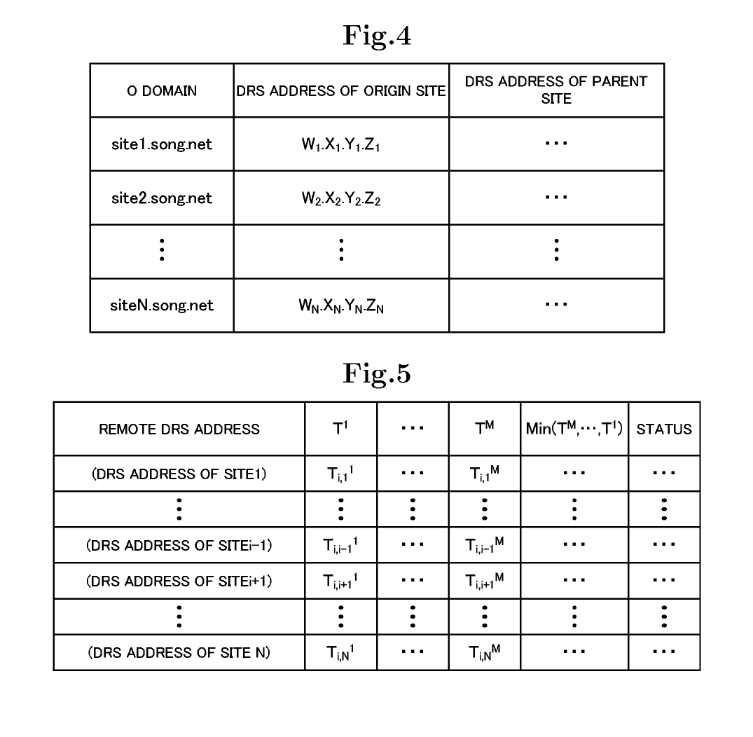

Here, FIG. 4 shows the table configuration of the parent DRS storing section 93. This table includes O domain, DRS address of the origin site, DRS address of the parent site, and DRS status of the parent site.

Further, FIG. 5 shows the table configuration of the RTT statistics storing section 94 in a DRSi (i=1, . . . , N), having N−1 pieces of entries relating to all sites other than the own site. Entries with respect to DRSj are combinations of addresses of DRSj (j=1, . . . , i−1, i+1, . . . , N), measurement values TjM, . . . , Tj1 of the RTTs of the past M times, the minimum value min(Tj1, . . . , TjM) thereof, and DRS statuses. When a new measurement value is obtained, M pieces of past measurement values of the RTTs are shifted to the left side and TjM is deleted, and the latest measurement value is written in the blank space of Ti1 on the right side, and the minimum value of the RTTs of the past M times is updated. This processing is performed by the parent DRS determination section 82.

### [Operation of Parent DRS Determination Section]

Next, operation of the above-described system will be described. First, operation of the parent DRS determination section 82 will be described with reference to FIGS. 6a and 6b.

FIG. 6a shows an operation of, when receiving a RTT statistics response in replay to transmission of an RTT statistics request to the DRS of another sire, measuring the RTT from the own site to the other site simultaneously, and if the RTT statistics vary, reconstructing the distribution tree. It should be noted that as described in Non-Patent Document 1, the distribution tree is for maximizing the entire throughputs between respective sites.

First at step S61, the parent DRS determination section 82 of each of the sites 101 and the like periodically transmits an RTT statistics request to the DRSs 302 and the like of all other sites 102 and the like. The period may be any predetermined period, which is 15 to 30 minutes, for example. At this moment, the number of timeouts N is set to 0.

Here, the RTT statistics request is an HTTP request having the following URI:

http://(DRS address of request target)/RTT statistics

Then, at step S62, if an RTT statistics response including

a vector of RTT statistics

{(DRS₁, T₁), . . . , (DRSⱼ₋₁, Tⱼ₋₁,), (DRSⱼ₊₁, Tⱼ₊₁), . . . , (DRS_{N},T_{N})}

(where Tₖ is RTT statistics measured from DRSⱼ to DRSₖ)

is returned with no timeout from DRS of another site 102 or the like to which the RTT statistics request is transmitted, the parent DRS determination section 82 writes the measurement value of the RTT (a period from the time that the request is transmitted until the time that the response is received) into the RTT statistics storing section 95 to update the statistics, and further updates the RTT matrix storing section 94 with the updated value. It should be noted that as the RTT statistics response, one in which the vector of the RTT statistics is described in XML may be used.

If timeout occurred, the parent DRS determination section 82 increments N and transmits a request again. The parent DRS determination section 82 repeats this processing, and if N exceed a predetermined value (for example, 3), writes a status of unusable in the status of the RTT statistics storing section 95, and also writes unusable in the RTT matrix storing section 94. Then, the parent DRS determination section 82 writes RTT statistics obtained from the responding sites to all other sites, within the RTT statistics response message, into the RTT matrix storing section 94. This operation is performed relating to all other sites to which the RTT statistics requests were made.

Then, at step 63, the parent DRS determination section 82 refers to the RTT matrix storing section 94 to calculate an optimum distribution tree in which each site becomes the origin site. Then, the parent DRS determination section 82 refers to the distribution tree storing section 96, and if there is an O domain in which the distribution tree includes changes, the parent DRS determination section 82 extracts the DRS of the parent site with respect to the O domain, updates the parent DRS storing section 93, and in the parent PS cache section 92, clears the portion with respect to the distribution tree having changes (identified by O domain), and further, in the address cache of the local PS, forcibly clears all entries of the B-URI including the O domain, and proceeds to step 61.

The reason of performing the clearing processing is, if the distribution tree is reconfigured, to allow each of the tables to immediately reflect the reconfiguration, without depending on TTL.

It should be noted that the method of specifying the parent DRS (parent domain resolution server) is to specify a DRS of the site closer to the route, of adjacent sites on the transfer path of the configured directed distribution tree, that is, the site on the upper stream side, as the parent DRS.

In step 63, it is assumed that the DRS of each site knows addresses of the DRSs of all other sites beforehand. This is realized in such a manner that the management system controlling the entire system notifies the all sites of the address of the DRS each time a site is added or deleted.

Further, as a method of calculating an optimum directed distribution tree at step 63, a method of maximizing the bottleneck (link having smallest band) as disclosed in Non-Patent Document 9 has been known. The object of this method is to maximize the transfer throughput between sites.

Here, if an RTT between adjacent sites and a maximum window size W are given, throughput at a link “e” between adjacent sites, if there is no packet loss, is given by W/Tₑ. As such, throughput on a path “h” between sites is given by, if a set of link “e” included in the path “h” is Eₕ, min_{eεEₕ}W/Tₑ which is the bottleneck on the path. Accordingly, if W is constant at respective links, throughput between sites can be maximized by applying Prim algorithm which is one procedure of creating a minimum entire tree, with Te being the cost. While a proof is led by referring to the method described in Non-Patent Document 10, it is not described herein. In this procedure, when adding a node to partial tree, a node at the destination of the link in which the RTT statistics stored in the RTT static matrix storing section are minimum values, among the links which can be added to the partial tree, is added.

It should be noted that a virtual link indicates that a link from a site A to a site B is not a physical one but is realized by a transfer function of the Internet or a dedicated network. Here, the procedure of creating the distribution tree can also be said as extracting an optimum directed distribution tree from the number of nodes and a full mesh directed graph of the number of directed links N(N−1).

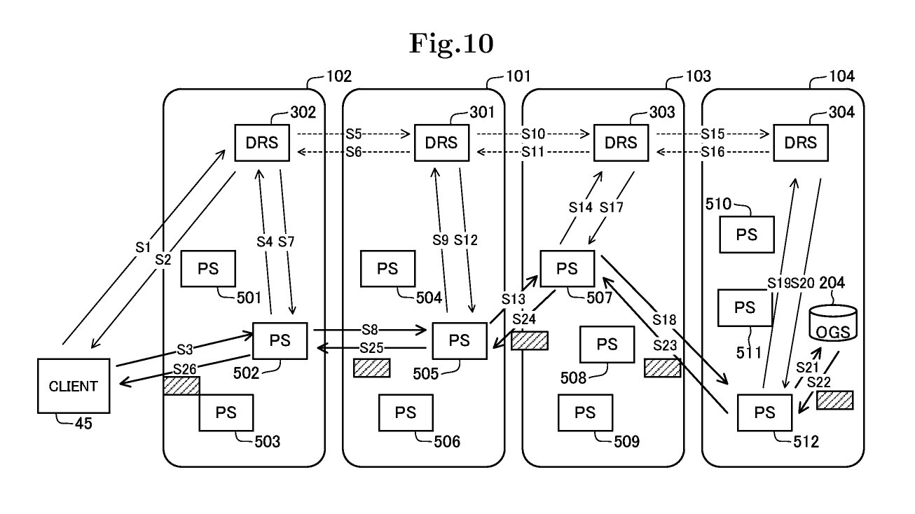

Further, as another method of calculating an optimum directed distribution tree at step 63, Dijkstra's algorithm has been known. However, RTT statistics are given to the edge cost from a site “i” to a site “j”, because it is desired to calculate the shortest path tree which minimizes the total sum of the RTTs on the link from each edge site to the origin site. If the time for domain resolution within the site is disregarded, this method is to approximately calculate the period from the time that a client first makes an HTTP request, regarding the file that the client wishes to acquire, to the edge site, to the time that the edge site first receives an HTTP response. The so-called startup time is given by two times the total sum of the RTT statistics at the virtual link between respective sites on the path in a direction from each edge site to the origin site. For example, in FIG. 10 as described below, this corresponds to the total sum of the RTT statistics of the virtual link relating to S5, S6, S8, S10, S11, S13, S15, S16, S18, S23, S24, and S25.

Further, FIG. 6b shows the processing when an RTT statistics request is received from the DRS of another site. When receiving an RTT statistics request from the DRS of another site at step S65, at step S66, the parent DRS determination section 82 transmits the RTT statistics relating to each remote DRS stored in the RTT statistics storing section 95, to the DRS requesting it in the RTT statistics response.

### [Operation of PS Assignment Section]

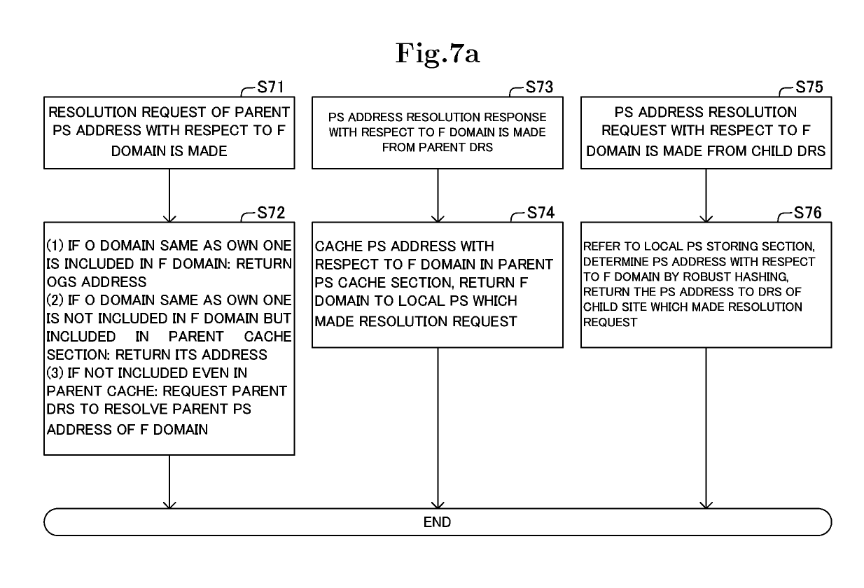

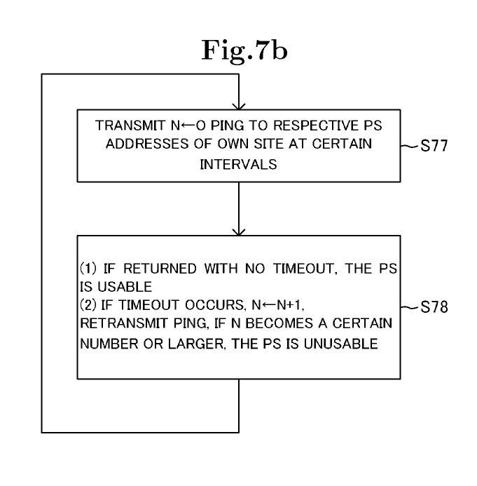

Next, operation of the PS assignment section 81 of the DRS 302 will be described with reference to FIGS. 7a and 7b. FIG. 7a shows the operation of domain resolution in the PS assignment section 81. Messages relating to domain resolution will be exchanged with 1) a client or a DRS of a child site, 2) a local PS, and 3) a DRS of a parent site. The procedures thereof with the respective counterparts will be shown below.

First, at step S71, if there is a domain resolution request of the parent PS with respect to the F domain from a client or a proxy of the own site, at step S72, (1) if the F domain includes an O domain which is the same as the own one, the PS assignment section 81 returns the address of OGS by a domain resolution response. (2) If the F domain does not include an O domain which is the same as the own one, and a corresponding entry is in the parent PS cache section 92, a domain resolution response is made accordingly. (3) If there is no corresponding entry, the PS assignment section 81 refers to the parent DRS storing section 93 to request the parent DRS corresponding to the O domain to resolve the parent PS address of the F domain.

Further, at step S73, if there is a domain resolution response from the DRS of the parent site, at step S74, the PS assignment section 81 caches the address of the PS assigned to the F domain in the parent PS cache section 92, and responds to the local PS which requested the resolution with the assigned address.

Further, at step S75, if there is a domain resolution request with respect to the F domain from the DRS of a child site, at step 76, the PS assignment section 81 refers to the local PS storing section 91 to determine the PS address corresponding to the F domain by robust hashing, and returns the address to the child DRS which requested the resolution to complete the processing.

FIG. 7b shows the monitoring operation of the local PS in the PS assignment section 81. At step S77, after a certain time period has elapsed from the previous monitoring operation, the number of timeouts N is set to 0, and the PS assignment section 81 transmits a ping to each PS address in the local PS storing section 91. At step S78, (2) if it is returned with no timeout, the PS assignment section 81 determines that the status of the PS is usable. (2) If timeout occurs, the PS assignment section 81 increments N and retransmits a ping. If the number of timeouts becomes a certain number or larger, the PS assignment section 81 determines that the status of the PS is unusable, and returns to step B7.

### [PS Assignment Algorithm at Step S76]

The robust hashing at step S76 in FIG. 7a is performed based on the method described in Non-Patent Document 11 or Patent Document 3. This method is to prevent the same content from being replicated to a plurality of PSs as much as possible, while when any PS is added or deleted, to minimize the rate that a PS, which is different from the existing PS having been assigned, is assigned to the F domain. When any server becomes unusable, as a child PS which has transferred data to such a server makes a resolution request to a child DRS and the chilled DRS further makes a request to the parent DRS, new assignment is made thereto.

Next, effects of the above-described first exemplary embodiment of the present invention will be described. According to the present embodiment, as the distribution tree having the respective sites as nodes is configured optimally without any limitation in the number of hops at the application level, it is possible to improve the throughput at the application level, compared with the case where the number of hops is limited. This means that as an optimum distribution tree is configured each time the origin site differs, the throughput can be further improved even when it is attempted to acquire content from any site, compared with the case of using a fixed distribution tree irrespective of the origin site.

Further, as a distribution tree is created as a directed graph having the origin site as the route based on the RTT measured between respective sites, even if asymmetric property in a transfer state between sites is large (for example, a difference between the RTT from a site A to a site B and the RTT from the site B to the site A is large), the throughput can be further optimized.

Further, as RTT measurement from the own site to another site and acquisition of RTT statistical information from the other site are performed simultaneously, there is no need to perform them in different procedures as described in Non-Patent Document 3, whereby the quantity of processing can be reduced.

### Example

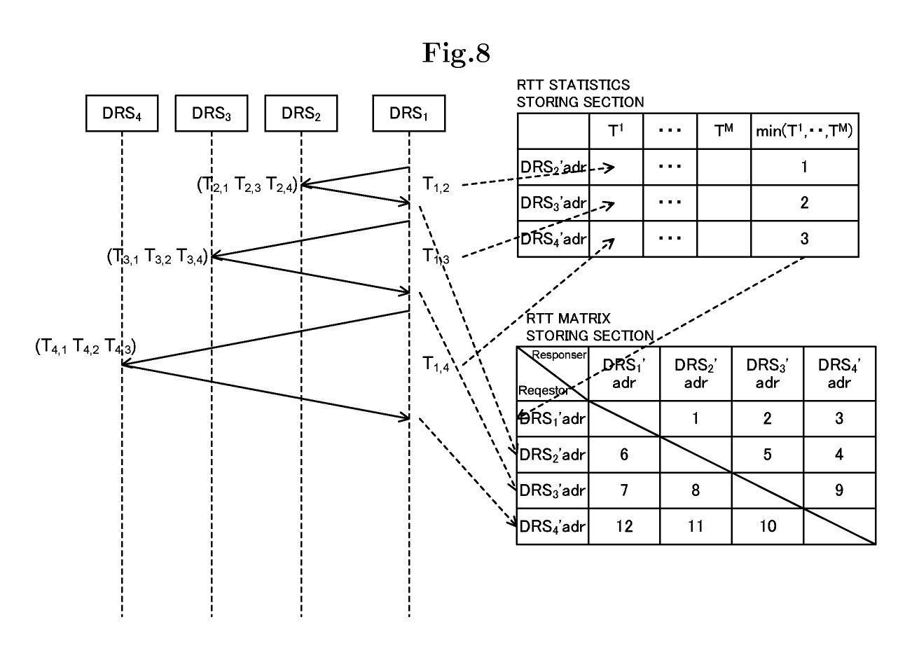

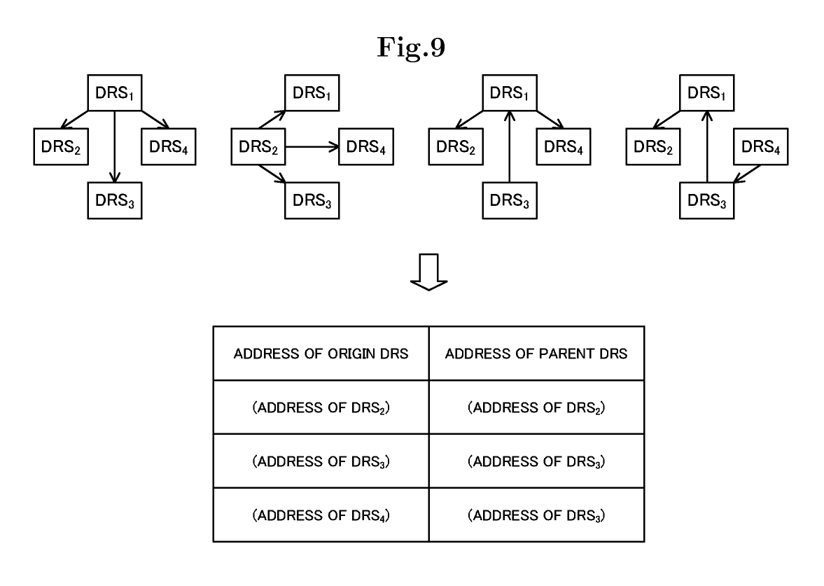

Next, a more specific example of the first exemplary embodiment will be described with reference to FIGS. 8 and 9. FIGS. 8 and 9 show operation of the parent DRS determination section 82.

FIG. 8 shows examples of acquisition of RTT statistical information, RTT measurement, and creation of an RTT matrix, in the DRS 1. In this example, after the DRS 1 transmits an RTT statistical information request to each of the DRS 2, the DRS 3, and the DRS 4, the DRS 1 measures an RTT at the same time as an RTT statistical information response being returned. Then, in the RTT matrix storing section 94, the RTT statistical information responded from each DRS is written in an entry in which each DRS is on the requesting side. Further, the measurement value of the RTT is written in the RTT statistics storing section 95, and new RTT statistics obtained as a result thereof are written in an entry in which oneself (DRS 1) is on the requesting side. As such, the value of the RTT measured as a time period, from the time of transmitting an RTT statistical information request to the time of response, is stored in the RSS statistics storing section 95, and the result processed as statistics is written in the RTT matrix storing section 94.

FIG. 9 shows an exemplary operation of creating a table of the parent DRS storing section 93 based on the contents of the RTT matrix storing section 94. Here, four directed distribution trees, in each of which each DRS serves as the origin site, are created. For each DRS, a correspondence table of each origin site and a parent DRS is as shown in FIG. 9, which is incorporated in the parent DRS address storing section 93. As such, in adjacent sites on the transfer path of a configured directed distribution tree, the DRS of a site closer to the route, that is, a site on the upper stream side, is specified as a parent DRS (parent domain resolution server).

Next, FIG. 10 shows an example of associated operation for acquiring data requested by a client from the origin site, by the operation of the PA assignment section 81.

First, a client has, in the metadata acquired from the OGS 204, F-URI of data that he/she wishes to acquire and the address of the DRS 302 of the parent site 102 which should be used to solve the PS from which the data is to be acquired. In order to acquire the address of the PS to which an HTTP request should be transmitted, the client transmits a domain resolution request with respect to the F domain included in the F-URI, to the DRS 302 (S1). For this step, an HTTP request including the following URI may be used:

http://(address of DSR 302)/PSes/f1578.site1.song.tv

Then, when the DRS 302 determines that a PS to be assigned to it within the site is the PS 502, the DRS 302 responds to the client with the address p.q.r1.s1 (S2). This response may be an HTTP response including the following information described in XML format:

f1578.siteLsong.tv p.q.r1.s1

Then, the client 45 transmits an HTTP request to the PS 502. Upon receipt of the HTTP request, as the data indicated by the URI is not cached, the PS 502 makes a request to the local DRS 302 to solve the F domain into the address of the parent PS to which the HTTP request should be transferred (S4). This may be performed by DNS protocol.

Then, as the DRS 302 does not have cache of the parent PS address with respect to the corresponding F domain, the DRS 302 refers to the parent DRS storing section 93 to make a resolution request of F domain to the DRS 301 which is the parent DRS corresponding to the O domain (S5). For this step, an HTTP request including the following URI may be used:

http://(address of DSR 302)/PSes/f1578.site1.song.tv

Then, the DRS 301 assigns the PS 505, and makes a resolution response to the DRS 302 with the address p.q.r2.s2 (S6). This response may be an HTTP response in which the following information described in XML format is included in the main text:

f1578.site1.song.tv p.q.r2.s2

As described above, a web service responding with a resource status in an XML file with respect to the designated URI is called RESTful (Non-Patent Document 7).

Upon receipt of the response, the DRS 302 makes a resolution response to the PS 502 which made a resolution request at S4 (S7). If the resolution request at S4 was made by the DNS protocol, the resolution response at S7 is also made by the DNS protocol.

When the same procedure is repeated up to the origin site 104, the HTTP request is transferred to the ORG 204 (S21). To this procedure, the ORG 204 returns the data designated in the F-URI to the PS 512 within the same site in the form of an HTTP response (S22). This is further transferred to the PS 507, the PS 505, and the PS 502 (S23, S24, S25), and finally reaches the client 45 (S26).

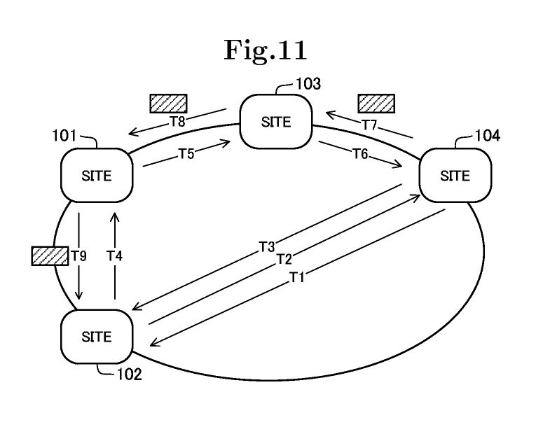

FIG. 11 shows an example of a series of operation for disposing data, having particularly high access frequency, from the origin site to the respective sites.

First, the DRS of the origin site 104 makes a domain resolution request to the DRS of the site 102 which is a leaf site on the distribution tree, to assign a PS to the URI of the content that it wishes to dispose (T1). Here, a “leaf site” indicates a site of the leading end with no transfer destination site, on the directed distribution tree.

Then, when a resolution response is returned from the DRS of the site 102 (T2), the DRS of the origin site 104 drives the assigned PS to issue an HTTP request to the URI with respect to the content (T3). Thereby, the PS in the site 102 transfers the HTTP request to the PS in the site 101 to which the HTTP request should be transferred next.

As the detailed procedure is the same as that of FIG. 10, it is not repeated herein. In a similar manner, the HTTP request is transferred from the site 102 to the origin site 104 on the distribution tree as T5 and T6. Based on it, the desired data reaches the site 102 from the origin site 104 via the sites 103 and 101 (T7, T8, T9). Each of the PSs in the sites 103 and 101 relays the data, and at the same time, stores the data as an original function of the PS.

Thereby, by only making a request from a leaf site, data is cached in non-leaf sites when it is transferred from the origin site. As such, there is no need to instruct issuance of an HTTP request from the origin site to all other sites. Further, data can be disposed by the same system as acquisition of data from the edge site using an HTTP request/response, so that no additional cost is required to incorporate new means in the PSs and the DRSs for push-type delivery from the origin site to each site.

Further, according to the above-described system, not only data of content to be transferred but also data to be used for controlling the overlay network for transfer are transferred using an HTTP request and an HTTP response including an XML file. As such, the protocols to be used are uniformed to HTTP, whereby operation of the overlay network for content distribution and delivery can be simplified. Further, as an HTTP response to be used for control can be described in XML format, it is possible to have flexibility in functionality extension.

### Second Exemplary Embodiment

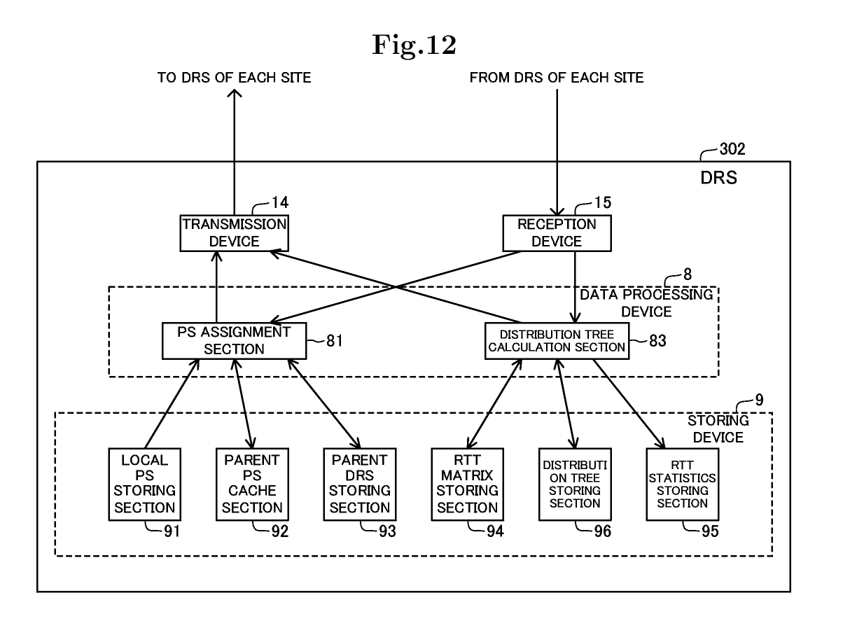

Next, a second exemplary embodiment of the present invention will be described with reference to FIGS. 12 to 15. This embodiment differs from the first exemplary embodiment in that the present embodiment is configured such that resolution of the parent DRS in each DRS is entirely performed by the DRS of the origin site.

FIG. 12 is a block diagram showing the configuration of a DRS. As shown in FIG. 12, a DRS of the present embodiment differs from the DRS shown in FIG. 5 only in the data processing device 8 which includes the PS assignment section 81 and the distribution tree calculation section 82.

In the distribution tree storing section 96, an entry of a combination of each site, other than the own site, and its parent site is stored, based on the distribution tree in which the own site is the route determined using the distribution tree calculation section 83.

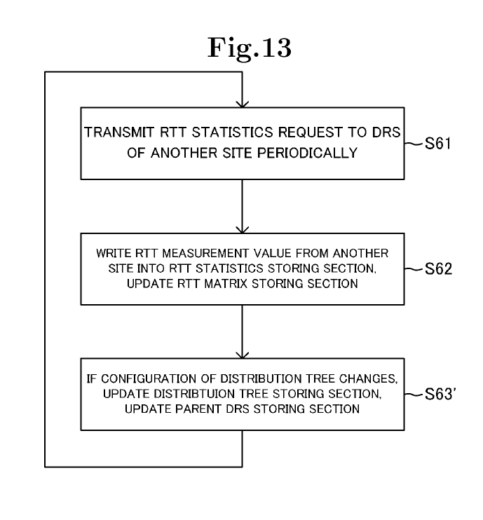

Next, operation of the second exemplary embodiment will be described. FIG. 13 is a flowchart showing the operation of creating a distribution tree, by the distribution tree calculation section 83, in which the route is itself.

Steps S61 and S62 are the same as those described in FIG. 6a of the first exemplary embodiment. Step S63′ is different from step S63 of FIG. 6a. In step S83′, only a directed distribution tree in which the own site is the origin site is calculated. Then, with reference to the distribution tree storing section 96, if the configuration of the newly calculated tree is changed, the distribution tree calculation section 83 updates the distribution tree storing section 96 to figure out another site in which a parent DRS has any changes, notifies the DRSs of all sites having changes of the new parent DRS, and returns to step S61. This notification may be performed by using an HTTP PUT request.

It should be noted that as the operation of the distribution tree calculation section 83 performed with respect to an RTT statistics request from another site is the same as the operation described in FIG. 6b, it is not repeated herein.

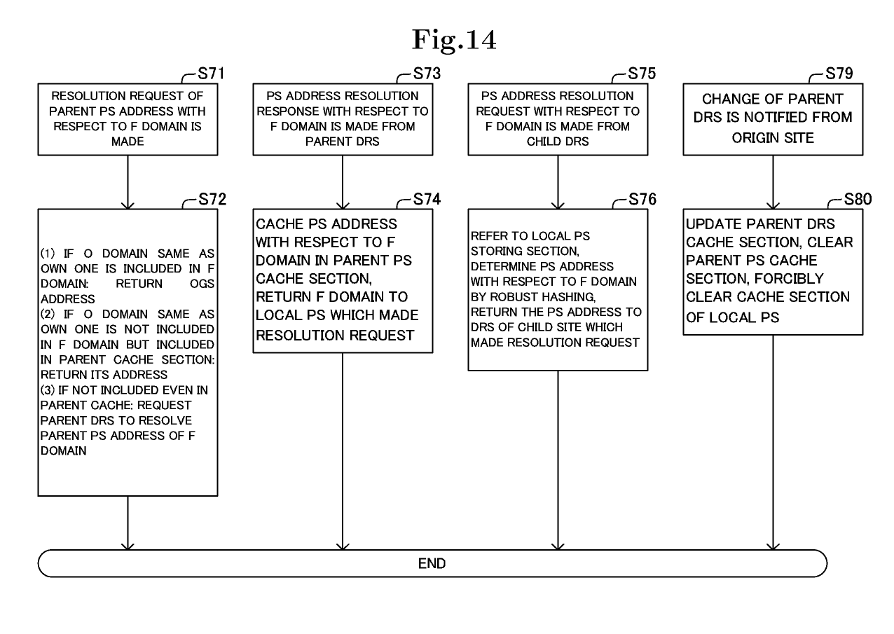

FIG. 14 is a flowchart showing the operation relating to domain resolution within the own site of the PS assignment section 81. Here, only functions added to those shown in FIG. 7a will be described.

If there is any change in a parent DRS from a DRS of an origin site at step S79, at step S80, the parent DRS storing section 93 is updated, and the parent PS cache section 92 clears the entries of all of the F domains including the O domain (it is known if the parent DRS storing section is referred to) corresponding to the DRS of the origin site, and in the address cache of the local PS, the entries of all B-URI including the O domain are forcibly cleared in the management procedure.

The reason for performing such clearing is that if the distribution tree is reconstructed, such reconstruction must be reflected immediately, without depending on TTL to update each of the tables. In addition, an operation of monitoring the local PS is also performed, which is the same as that described in FIG. 7b.

According to the configuration of the second exemplary embodiment described above, each DRS calculates only a distribution tree in which the DRS itself forms the route, and notifies all other DRSs of the parent DRS which is updated after the reconfiguration thereof. Accordingly, the present embodiment has the following advantageous effects, compared with the first exemplary embodiment of distributed type in which the DRS of each site creates a parent DRS table independently. One effect is to deduce the time in which the optimum property of an HTTP transfer path is lost due to inconsistency in the contents of the parent DRS tables held by the respective DRSs. The best example of the optimum property being lost is that as the path is changed before and after the reconstruction of the distribution tree, an HTTP request may return to the same PS. This can be detected if the PS finds out that the own address is described in the X-Forwarded-For header.

Further, while, in the first exemplary embodiment described above, the DRS of each site needs to calculate all distribution trees in which the site of each DRS forms the route, in the second exemplary embodiment, it is only necessary to calculate a distribution tree in which the DRS itself forms the route, whereby the quantity of calculation can be reduced.

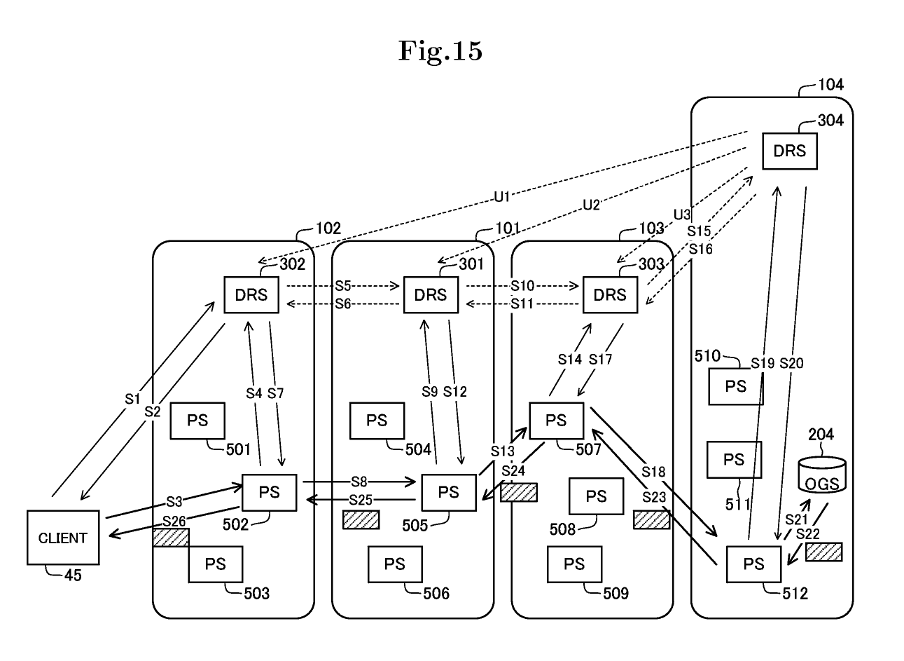

Next, an example relating to the second exemplary embodiment will be described with reference to FIG. 15. This example is different from that shown in FIG. 10 described in the first exemplary embodiment. In this example, when the distribution tree is changed, the DRS 304 of the origin site notifies each DRS in which the parent DRS has changed of a combination of the O domain and the parent DRS. In this example, the DRS 304 notifies the DRS 302, the DRS 301, and the DRS 303 in U1, U2, and U3. As the other operation is the same as that described in FIG. 10, the detailed description thereof is not repeated herein.

### Third Exemplary Embodiment

Next, a third exemplary embodiment of the present invention will be described. This embodiment is characterized in that in order to further improve the throughput on the path by the optimum distribution tree set in the first and second exemplary embodiment, blocks of data formed by dividing a file by the ORG are transferred in parallel between sites. However, a control load is reduced by performing domain resolution not in units of blocks but in units of substreams transferred in parallel.

### [Origin Server (OGS)]

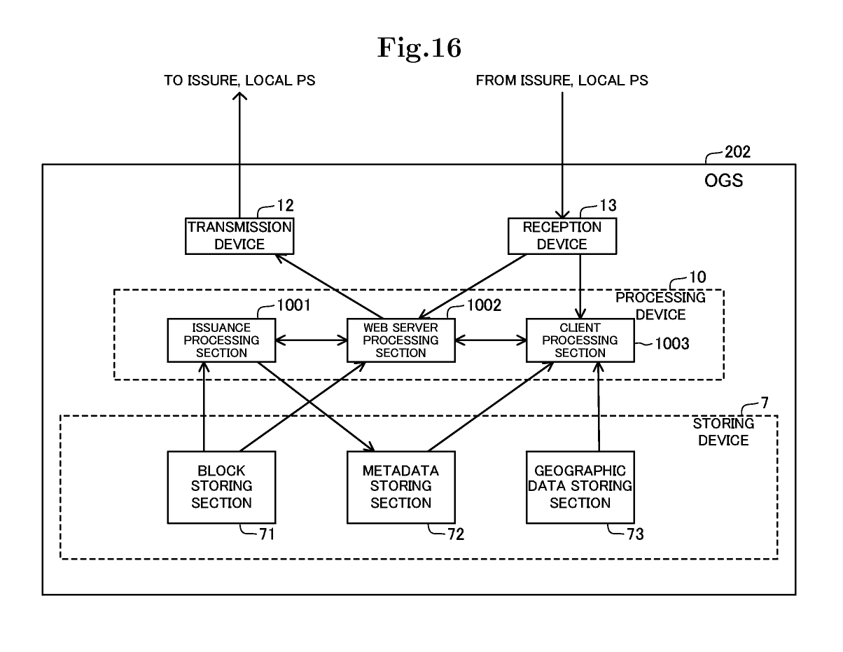

As shown in FIG. 16, an origin server (OGS) 2 of the present embodiment includes a transmission device 12, a reception device 13, a processing device 10, and a storing device 7.

The processing device 10 (content delivery means) includes an issuance processing section 1001, a web server processing section 1002, and a client processing section 1003, which are constructed by a program being installed.

The web server processing section 1002 has a function of transmitting data of content with respect to an HTTP request received from a client, and creating stored data into HTML data and transmitting it by HTTP. Particularly, in the present embodiment, with respect to a plurality of PSs disposed in the same site on the path, substream data consisting of a group of blocks formed by dividing content is delivered in parallel to the client, as described below.

The issuance processing section 1001 is implemented by a processing application such as providing and transforming URI with respect to acquired data.

When the client processing section 1003 receives, from the web server processing section 1002, a metadata request from a client, the client processing section 1003 extracts corresponding metadata, determines a DRS of the nearest edge site with reference to a geographic data storing section 73 based on the IP address of the client, adds it to the metadata, and provides the web server processing section 1002.

The storing device 7 includes a block storing section 71, a metadata storing section 72, and the geographic data storing section 73. The block storing section 71 stores data of uploaded content. The metadata storing section 72 stores O-URI, B-URI represented parametrically, and metadata given by the issuer. The geographic data storing section 73 stores the address of the DRS of each site and the range of corresponding IP address. It should be noted that the storing device 7 is realized by a storage server or the like having a relatively large capacity, for example.

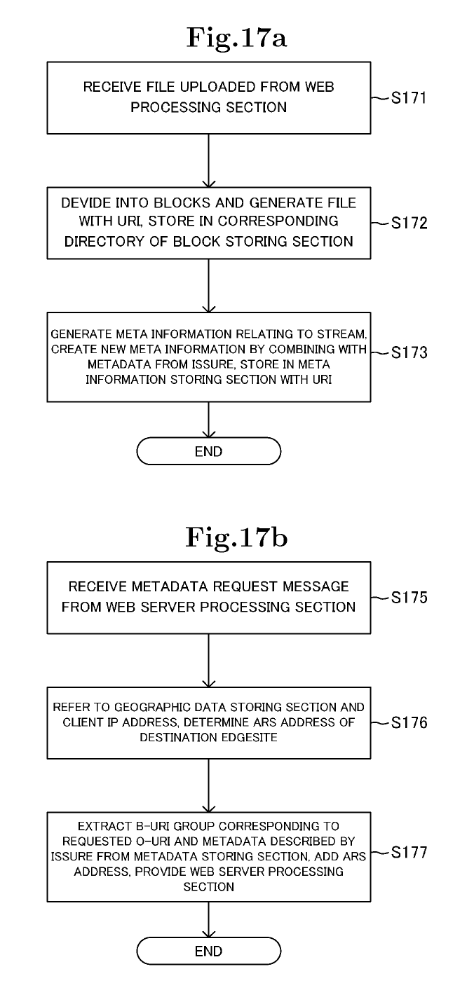

Next, operation of the issuance processing section 71 of the ORG will be described in detail using FIG. 17a. First, at step S171, upon receipt of data uploaded from the web server processing section 1002, the issuance processing section 71 divides the file into one or more blocks at step S172, gives URI to each block, and stores in the block storing section 71. Then, at step S173, the issuance processing section 71 creates metadata, integrates it with the metadata from the issuer to create mew metadata, gives URI, and stores it in the corresponding metadata storing section 72.

Next, the URI given for each block at step S127 will be described. First, respective blocks are not necessarily the same size. When respective blocks are transferred in parallel, a set of blocks to be transferred on the HTTP connections of the same PSs are called substream data. As such, parallel transfer means simultaneously transferring a plurality of substreams each including a plurality of blocks formed by dividing content (divided data).

However, in order that a client is able to replay video immediately after reception, the respective blocks are adapted to belong to different substreams in a cyclic manner. As such, if the total number of substreams is Z, a substream ID with respect to a block ID is given as follows:

(substream ID)={(block ID)−1} mod Z+1

As such, if each block has a block ID which is an identification number corresponding to the sequence of replaying the content, a reminder value (in practice, reminder value+1) calculated by dividing the block ID (in practice, block ID−1) by the total number Z of the substreams is set to be the ID of the substream to which the block is arranged. In this case, for each substream, by arranging the blocks in the order starting from the smallest block ID, the respective blocks are arranged distributedly from the heading of respective substreams, in the order starting from one being replayed first on the content. Thereby, even if respective substreams are transferred in parallel, the data can be delivered from the heading of the content.

Then, in order that a PS is able to perform domain resolution such that a PS is assigned for each substream, URI transformation as shown below is performed. It is assumed that the total number Z of substreams is determined to be Z=3 in advance. Further, in the ORG (identified by site1 in this example), URI given for each program file immediately after uploading (this is referred to as O-URI) has the following structure:

O-URI: http://www.site1.song.net/videocast/channel3/item2/

Here, “song.net” indicates the main body providing the delivery service, “site1” indicates the origin site which is the upload destination of this content from the issuer, and “www” indicates the host name as the origin server. If the delivery service provider operates N pieces of sites, respective sites may be shown as site1, . . . , siteN, for example. Further, in the path, “videocast” indicates the name of a content providing service, “channel3” indicates an individual channel, and “item2” indicates an individual delivery program.

The URI given to a block obtained by segmenting this file is called B-URI in which the block number is added to the end of the O-URI.

B-URI: http://www.site1.song.net/videocast/channel3/item2/block6

As described in the background art section, even in Non-Patent Document 1, an HTTP request including an equivalent of B-URI is transferred to a PS on the relay path. However, while B-URI is given by the OGS in the present invention, in Non-Patent Document 1, B-URI is given by the proxy to which an HTTP request, including an equivalent of O-URI, is first transferred from the client.

Next, the B-URI is transformed as follows in order that the PS is able to assign a proxy server to each of the substreams which are formed of the blocks of the same item:

(1) First, O-URI is hashed (this value is assumed to be 1578 in this example), “f” is added thereto to form f1578, and z3 obtained by add z to the number of substreams 3 is added thereto to form a domain z3f1578.

(2) Next, with respect to the substream ID 2 for the block ID 6, and to the total number of substreams 3, a domain s2 is formed.

(3) Finally, a domain s2.z3f1578, formed by combining them, is replaced with “www” of the first B-URI.

Then the transformed B-URI is as follows:

http://s2.z3f1578.site1.song.net/videocast/channel3/item2/block6

Here, the domain corresponding to the same file as z3f1578.site1.song.net is called F domain, and the domain corresponding to a different substream in the same file as s2.z3f1578.site1.song.net is called S domain. If a client or a PS is different from the existing one so that domain resolution can be requested for each URI, the f1578 part is unnecessary.

The URI transformed as described above is written in the metadata to be used when the user acquires the target file, and stored in the metadata storing section 72.

It should be noted that the reason of inserting the sign “z3” in the above-described transformation is that when transmitting a domain resolution request relating to the destination PS to the DRS of the parent site, a message of resolution request is not transmitted for all of the three S domains corresponding to the same F domain. When a domain resolution request relating to any of the S domains is first made by a local PS, a domain resolution request for PS assignment for the F domain is made. This can be performed by an HTTP request having the URI shown below, for example:

http://(address of parent DRS)/P Ses?F-domain=z3f1578.site1.song.net.

When the parent DRS receives this request, the parent DRS is able to reproduce the three S domains from “z3” immediately and assign a PS to each of them. Combination of these three may be represented as follows:

s1.z3f1578.site1.song.tv v.w.x.y1

s2.z3f1578.site1.song.tv v.w.x.y2

s3.z3f1578.site1.song.tv v.w.x.y3

This information may be described in XML format and included in an HTTP response to the parent DRS. A web service which responds to such designated URI with the resource status in an XML file is called RESTful (Non-Patent Document 7).

Here, if sequential reproduction is unnecessary and it is desired to simply transfer the entire file, the entire file can be divided into 3 blocks for example, and as transformed B-URI, it is only necessary to prepare B-URI for the number of substreams in which the substream ID and the block ID are set one to one as follows:

http://s1.z3f1578.site1.song.net/videocast/channel3/item2/block1

http://s2.z3f1578.site1.song.net/videocast/channel3/item2/block2

http://s3.z3f1578.site1.song.net/videocast/channel3/item2/block3

Next, the metadata at step S173 will be described. The OGS creates the metadata as shown below and stores it in the metadata storing section 72. This is accessed from the client with an HTTP request including O-URI.

O-URI: http://www.site1.song.net/videocast/channel3/item2/

Address of edge site DRS: 291.47.234.12, 291.47.234.13

A group of B-URI in substream 1:

http://s1.z3f1578.site1.song.net/videocast/channel3/item2/block(3n+1);

n=0, . . . , 1000

A group of B-URI in substream 2:

http://s2.z3f1578.site1.song.net/videocast/channel3/item2/block(3n+2);

n=0, . . . , 1000

A group of B-URI in substream 3:

http://s3.z3f1578.site1.song.net/videocast/channel3/item2/block(3n+3);

n=0, . . . , 1000

In the above description, if every B-URI relating to the blocks which should be acquired for building a program file is simply written, the information quantity will become enormous if the total number of blocks is large, so parametric expression is used for each substream in order to prevent such enormous quantity. Further, the DRS address of the edge site to which the client should be led is determined based on the IP address or the like of the client at the time when the client requests the metadata. This example describes two DRS addresses in the determined optimum edge site, in consideration of a DRS failure.

Next, operation of the client processing section 1003 will be described using FIG. 17b. At step S175, when receiving a metadata request message from the web server processing section 1002, at step S176, the client processing section 1003 refers to the geographic data storing section 73 and the client IP address to determine the DRS address of the edge site to which the client is led, extracts a group of B-URI corresponding to the requested O-URI and the metadata described by the issuer from the metadata storing section at step S177, adds the DRS address thereto, and provides it to the web server processing section 1002 to complete the processing.

### [Domain Resolution Server (DRS)]

The configuration of the DRS is the same as that of FIG. 5 if reconstruction of a distribution tree is performed distributedly as described in the first exemplary embodiment, while it is the same as that of FIG. 12 if reconstruction of distribution tree is performed in a concentrated manner as described in the second exemplary embodiment.

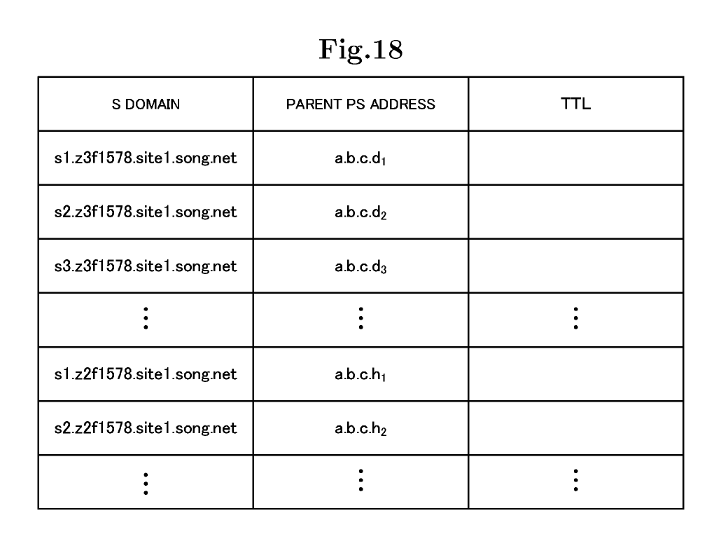

FIG. 18 shows the table configuration of a parent PS cache section included in the DRS. While the table has an entry including a combination of F domain and a parent PS address in the first and second exemplary embodiments, in the present embodiment, the table has an entry including a combination of S domain and a parent PS address with respect to the same F domain.

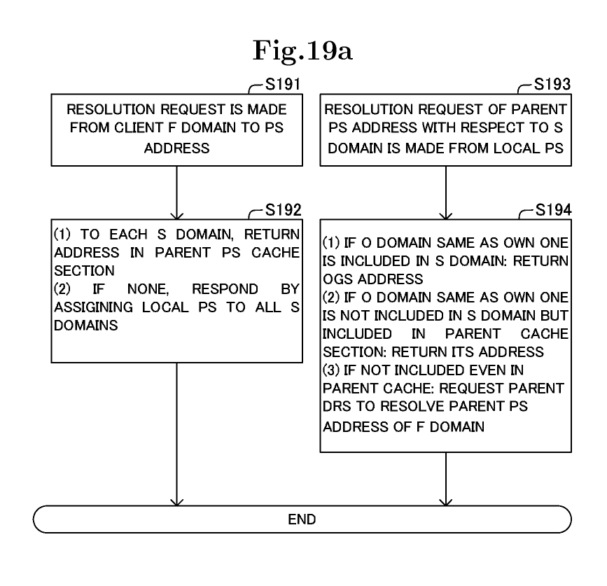

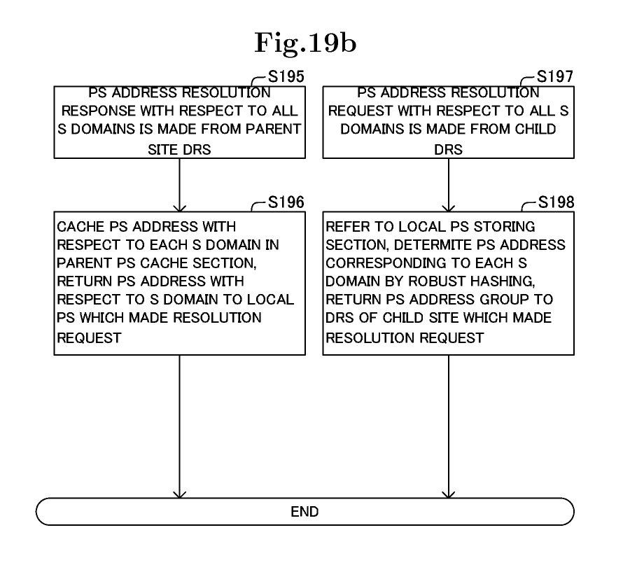

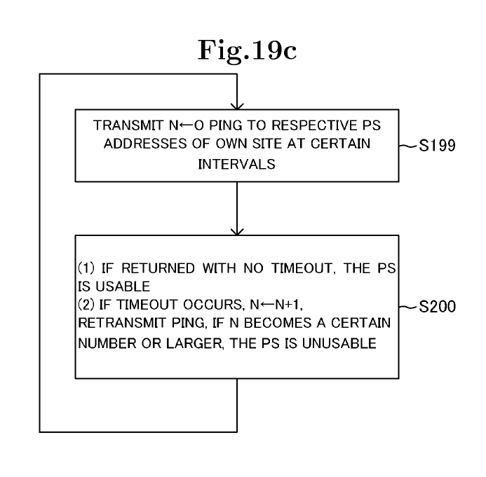

Next, operation of the DRS will be described. As described in the first exemplary embodiment, if reconfiguration of a distribution tree is performed distributedly, operation of the parent DRS determination section is the same as that of FIG. 6. Further, if reconstruction of a distribution tree is performed in a concentrated manner as described in the second exemplary embodiment, operation of the distribution tree calculation section is also the same as that of FIG. 13. With use of FIGS. 19a, 19b, and 19c, operation of the PS assignment section 81 when reconstruction of a distribution tree is performed distributedly will be described specifically.

FIG. 19a is a flowchart showing the operation when a domain resolution request is made from a client or a local PS to the S domain. At step S191, when a resolution request is made from a client F domain to the parent PS address, at step S192, to each S domain, the DRS responds to the request by (1) returning the address in the parent PS cache section, or (2) if there is no address, assigning a local PS to all of the S domains.

At step S193, if a resolution request of the parent PS address with respect to the S domain is made from a local PS, at step S194, (1) if the S domain includes the O domain which is the same as the own one, the DRS returns the address of the OGS with an address resolution response. (2) if it is not included, the DRS returns the address in the parent PS cache section, and (3) if there is no address, the DRS refers to the parent DRS storing section and transmits, to the parent DRS corresponding to the O domain, a resolution request from the F domain to the parent PS address. Here, a domain resolution request from a local PS and a response are made using the existing DNS protocol.

FIG. 19b is a flowchart showing the operation if there is a domain resolution response from the DRS of the parent site or there is a domain resolution request to all of the S domains from the DRS of a child site, in the PS assignment section 81.

At step S195, if there is a domain resolution response from the DRS of the parent site, at step S196, the address of the PS assigned to the S domain is cached in the parent PS cache section, and a response is made with the address assigned to the local PS which made the resolution request. At step S197, when a domain resolution request is made from the DRS of a child site to all of the S domains, at step S198, a group of PS addresses corresponding to the respective S domains are determined by robust hashing by referring to the local PS storing section, and the addresses are returned to the child DRS which made the resolution request to complete the processing.

It should be noted that the robust hashing at step S198 is performed based on the method disclosed in Non-Patent Document 11 or Patent Document 3. This method is to prevent the same content from being replicated to a plurality of PSs as much as possible, while when any PS is added or deleted, to minimize the rate that another PS is assigned to the S domain to which the existing PS has been assigned.

FIG. 19c shows the monitoring operation of the local PS in the PS assignment section 81. At step S199, after a certain time period has elapsed from the previous monitoring operation, the number of timeouts N is set to 0, and the PS assignment section 81 transmits a ping to each PS address in the local PS storing section. At step S200, if it is returned with no timeout, the PS assignment section 81 determines that the status of the PS is usable. If timeout occurs, the PS assignment section 81 increments N and retransmits a ping. When the number of timeouts becomes a certain number or larger, the PS assignment section 81 determines that the status of the PS is unusable, and returns to step S199.

### [Proxy Server (PS)]

Next, a proxy server (PS) according to the present embodiment will be described. As each substream has an individual domain name, each PS of the local site resolves the PS address of the parent site for each substream using the DRS of the local site. Next, with respect to the resolved address of the parent PS, a single HTTP persistent connection is set, and for each block in the same substream, HTTP requests are sequentially output in a pipelining manner on the same connection, that is, in a sequence in which block number in the B-URI ascends, and data blocks are acquired with HTTP responses.

Here, HTTP connections are not set for different URI included in the metadata, that is, in units of blocks. Persistent connection and pipelining are described in Non-Patent Document 12.

### [Client]

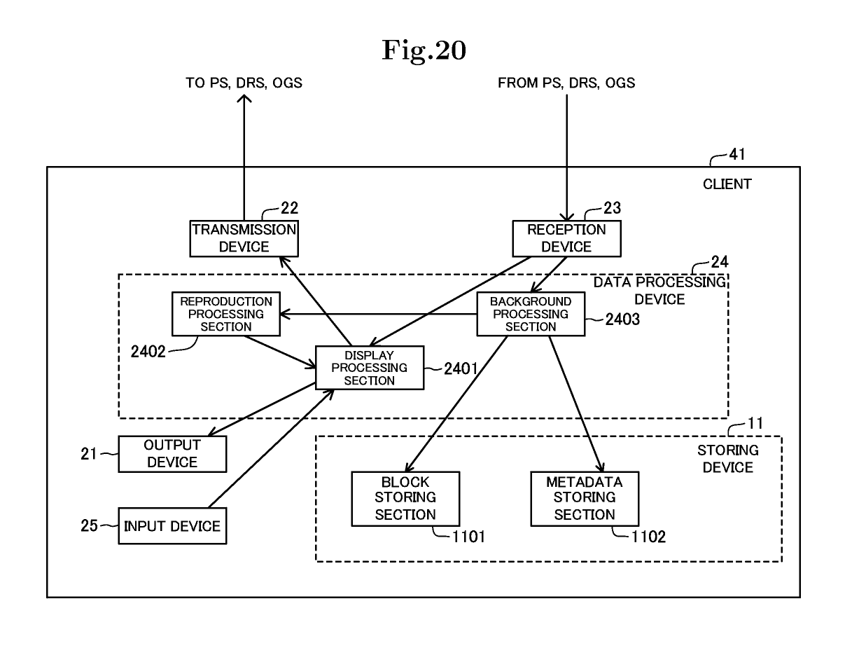

Next, a client according to the present embodiment will be described. As shown in FIG. 20, a client 41 includes a transmission device 22, a reception device 23, a data processing device 24, a storing device 11, and input device 25, and an output device 21. Here, the input device 25 and the output device 21 are used by a user, which may be a keyboard and a liquid crystal display respectively, for example.

The data processing device 24 includes a reproduction processing section 2402, a display processing section 2401, and a background processing section 2403. The display processing section 2401 changes the display based on an input signal from the input device 24 of the user, processes the data received from the reproduction processing section 2402, and provides the output device 21 with the processed data.

The background processing section 2403 transmits and receives data according to an instruction from the display processing section 2401 via the transmission/reception device. As such, the background processing section 2403 also performs domain resolution with the DRS of the edge site. It should be noted that the background processing section 2403 and the display processing section 2401 are included in the main function of the web browser.

When the reproduction processing section 2402 receives an instruction to start reproduction from the background processing section 2403, the reproduction processing section 2402 sequentially extracts blocks from the block storing section 1101, and if it is a video, performs decoding and displays it on the output device 21. It should be noted that the storing device 11 is formed of a block storing section 1101 and a metadata storing section 1102.

Next, operation of the client will be described. First, relating to a link to a program item shown on the web screen displayed on the output device 21, when a signal that the link is clicked is transmitted from the input device 25 to the display processing means, a request for metadata is transmitted to the ORG. Then, when the display processing section 2401 acquires the metadata from the OGS, the display processing section 2401 stores it in the metadata storing section 1102, and outputs an instruction to acquire content to the background processing section 2403.

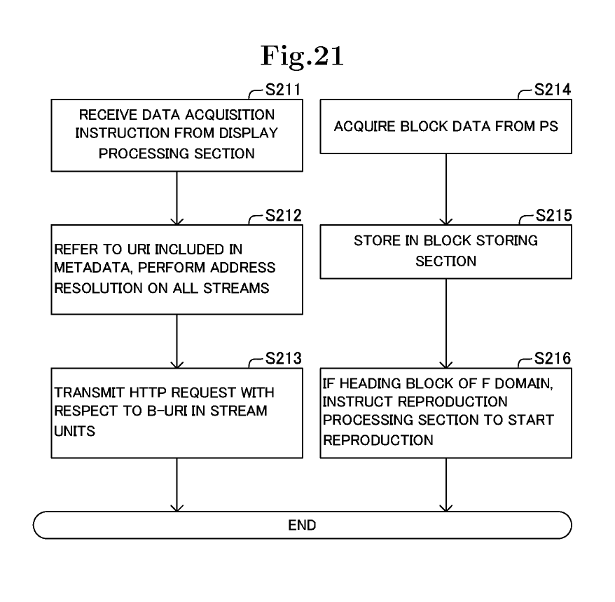

FIG. 21 is a flowchart for describing the subsequent operation of the background processing section 2403 of the client. At step S211, when the background processing section 2403 receives a content data acquisition instruction from the display processing section 2401, at step S212, the background processing section 2403 extracts the metadata from the metadata storing section 1102, and performs domain resolution of the PS collectively with respect to all of the S domains in the group of parametric URI described in the file of the metadata.

At step S213, the background processing section 2403 sets a persistent HTTP connection to each PS in which domain resolution has been performed, and transfers HTTP requests with respect to different blocks belonging to the same substream in pipelining to complete the processing.

At step S214, when receiving block data as a HTTP response relating to B-URI, the background processing section 2403 stores it in the block storing section 1101 at step S215. At step S216, if the acquired block is the heading block relating to the F domain, the background processing section 2403 instructs the reproduction processing section 2402 to start reproduction.

With the above-described configuration, even if the case of segmenting a file and transferring them in units of blocks, domain resolution is performed for each substream in the present embodiment. As such, it is possible to reduce the number of messages required for domain resolution, compared with the case of performing domain resolution for each block (identified by B-URI in this example).

Further, as domain resolution for assigning PSs to respective substreams is performed collectively, it is possible to reduce the number of messages required for domain resolution, compared with the case of performing domain resolution for each substream.

Further, as a persistent connection is set for each substream between a client and a PS and between a pair of PSs on the path, and respective blocks included in the same substream are transferred on the same persistent connection which has been set once, it is possible to reduce a processing load and a setting delay, compared with the case of setting an HTTP connection for each block by a PS as described in Non-Patent Document 1.

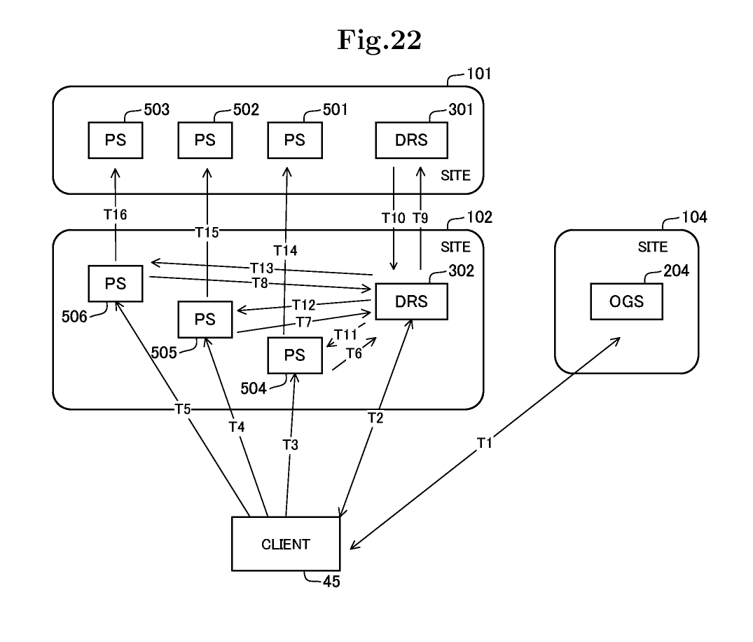

Next, operation according to the present embodiment will be described. First, FIG. 22 shows an exemplary operation of domain resolution. On the top page to be accessed by the client, a link to metadata information is provided. This includes O-URI. When the link is clicked, metadata (B-URI in each substream is parametrically expressed) and a JavaScript program for realizing the above-described background processing section 2403 are downloaded from the OGS (T1). Here, JavaScript which is a program operating on the web browser of the client is described in Non-Patent Document 13.

Next, when the background processing section 2403 of the client collectively makes a domain resolution request for the domains s1, s2, and s2 included in the metadata to the DRS 302 shown in the metadata, for each of the domains, addresses of a plurality of PSs disposed in the same site 102, that is, the addresses of the PSs 504, 505, and 506, are resolved (T2).

Next, to each PS having the resolved address, a persistent connection is set, and an HTTP request including the URI corresponding to the first block included in each substream is made (T3, T4, and T5). Then, as each PS has no cache, each PS makes a domain resolution request of the parent PS for the S domain that each PS handles, to the local DRS 302 (T6, T7, and T8).

Next, the PS assignment section of the DRS 302 outputs a resolution request of the F domain to the parent site DRS 301 at timing that any one of the domain resolution requests of T6, T7, and T8 is first received (T9). In response, when the DRS 301 returns, to the DRS 302, the addresses of the PS 501, PS 502, and PS 503 to the respective domains including s1, s2, and s3 (T10), resolution is made with the PS addresses corresponding to the PS 501, PS 502, and PS 503 (T11, T12, and T13). Each of the PSs sets a persistent connection to the parent PS received, and outputs an HTTP request including B-URI including s1, s2, and s3, which are the substream IDs, in a pipelining manner of HTTP1.1 (T14, T15, and T16).

It should be noted that both client and PS are able to make an HTTP request to each block in the substream having the same domain name by URI transformation without performing domain resolution for each block once a PS which should be assigned first to the domain is resolved.

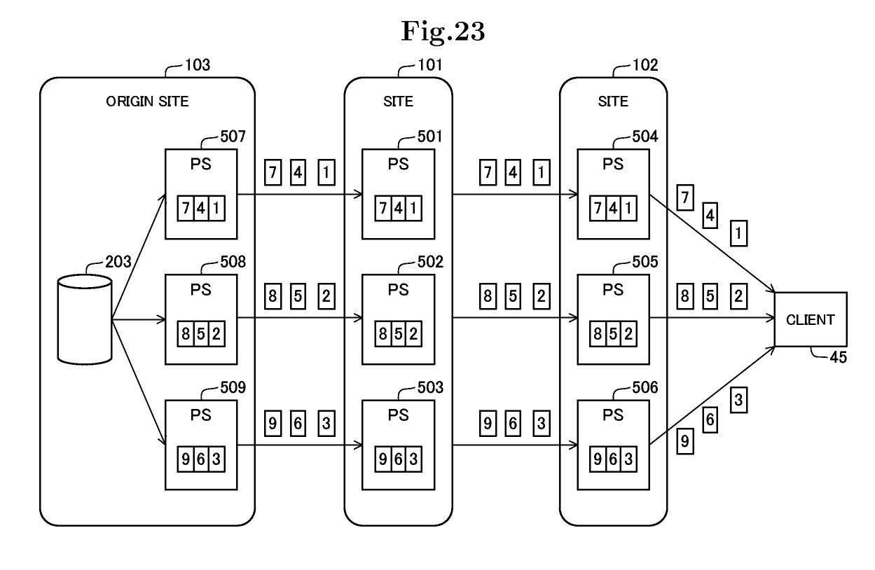

FIG. 23 is an illustration showing parallel transfer states of substreams and the sequence of block numbers in the substreams. In this case, there are three substreams, and the blocks transferred in each substream and their sequences are as follows:

s1: block1, block4, block7, . . .

s2: block2, block5, block8, . . .

s3: block3, block6, block9, . . .

The PSs assigned to st1, st2, and st3 in the origin site 103 are 507, 508, and 509. The PSs assigned to st1, st2, and st3 in the relay site 101 are 501, 502, and 503. The PSs assigned to st1, st2, and st3 in the edge site 102 are 504, 505, and 506. The blocks received by the background processing section from the respective connections like round-robin in the client 46 are sequentially assembled and reproduced by the reproduction processing section in the client.

As described above, in the present embodiment, as the origin site 103 delivers in a parallel manner, substream data consisting of a group of blocks formed by dividing the content to a plurality of PSs arranged in the same site on the path, it is possible to further improve the throughput.

It should be noted that while the case of transferring, in a parallel manner, a plurality of units of substream data to a plurality of PSs on the same site in accordance with the path based on the directed distribution tree provided in the domain resolution server has been described as in the first and second exemplary embodiments, it is also possible to transfer a plurality of units of substream data in a parallel manner to a plurality of PSs on the same site in accordance with a preset path.

### Fourth Exemplary Embodiment

Next, a fourth exemplary embodiment of the present invention will be described in detail with reference to the drawings. The present embodiment is characterized in that if the number of HTTP connections which can be set by the client from the browser is limited, high-speed transfer is realized using substreams of the number constant factor times the number of the HTTP connections in the transfer network.

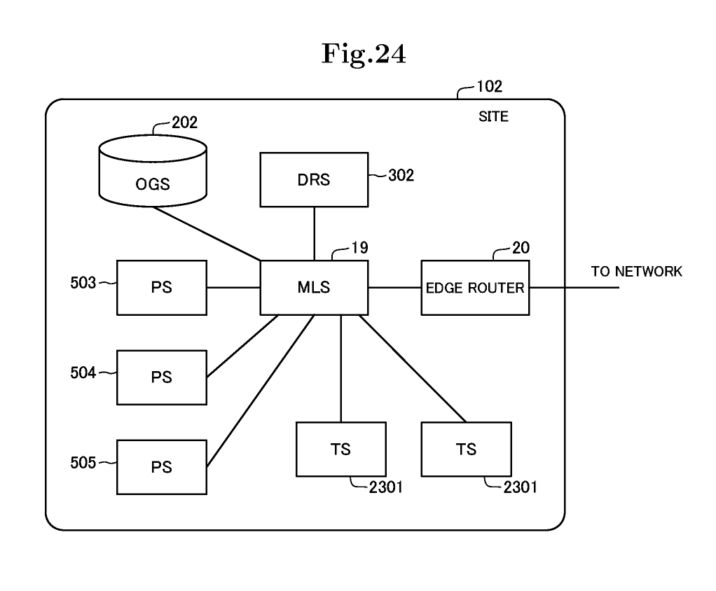

FIG. 24 is a diagram illustrating the configuration of a site. In addition to the configuration of the first exemplary embodiment, transformation servers (relay servers) 2301 and 2302 (hereinafter referred to as “TS”) are added in the server. The transformation servers 2301 and 2302 directly exchange data with a client having a restriction in the number of connections to be set, and also exchange data by setting HTTP connections with PSs within the same site. Thereby, the TSs migrate substreams. To be specific, the TS has a function of transmitting and receiving substream data in the predetermined number of sessions with a PS, and with the client, gathering the substream data within the range of the upper limit number of sessions connectable by the client and transfers it to the client (transfer means).

However, different from the PSs, the TSs do not cache blocks distinguishable by the URI. For the TSs and the PSs, different IP addresses are given, and the DRS 302 is able to distinguish TSs from PSs from the source address of the transmitted data.

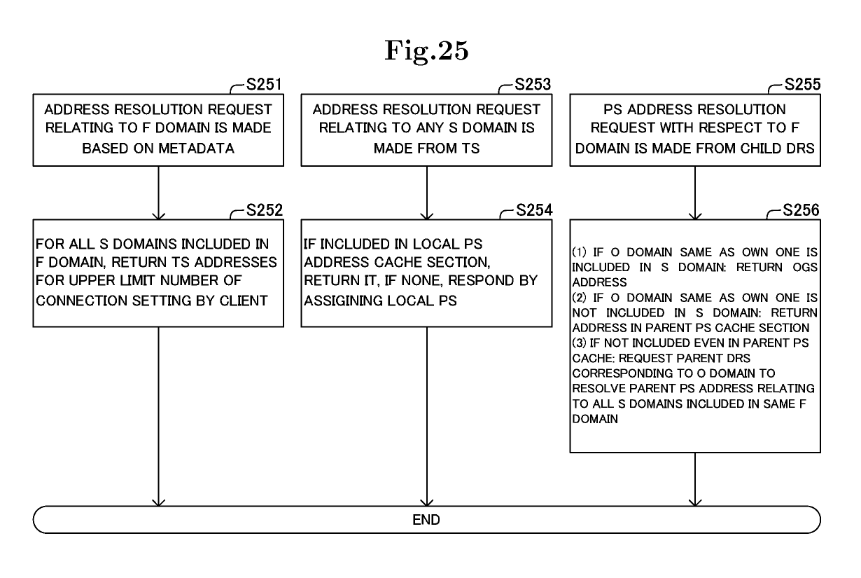

FIG. 25 is a flowchart showing the operation of the PS assignment section of the DRS 302. Here, only the part different from the third exemplary embodiment will be described. FIG. 19a is deformed as follows.

At step S251, if a resolution request of F domain is made as an HTTP request from the client, at step S252, the PS assignment section assigns a TS to each of all of the corresponding S domains, and returns the address. However, the number of different TS addresses must be the upper limit number or less of connection setting of the client.

At step S253, if a resolution request of the S domain is made from a TS, at step S254, if the local PS assigned to the corresponding S domain is in the local PS cache section, the PS assignment section returns it, while if it is not included, the PS assignment section assigns local PSs to all of the S domains by robust hashing and returns the addresses.

At step S255, if a resolution request relating to the S domain is made from a local PS, at step S256, (1), (2) the PS assignment section refers to the parent PS cache section and respond, while (3) if there is none, the PS assignment section makes a domain resolution request of the parent PS with respect to all of the S domains, to the parent DRS corresponding to the O domain. While the TS operates similarly to the PS, if an HTTP response is returned, the PS may cache the data but the TS does not cache it.

The robust hashing at step S256 is performed based on the method disclosed in Non-Patent Document 11 or Patent Document 3. This method is to prevent the same content from being replicated to a plurality of PSs as much as possible, while when any PS is added or deleted, to minimize the rate that another PS is assigned to the S domain to which the existing PS has been assigned.

With the above configuration, as a TS for migrating a substream is put in between a PS and a client, even if the client has the upper limit in the number of HTTP connections to be set, the present embodiment is able to improve the throughput by independently setting the total number of substreams which are transferred in parallel within the distribution network.

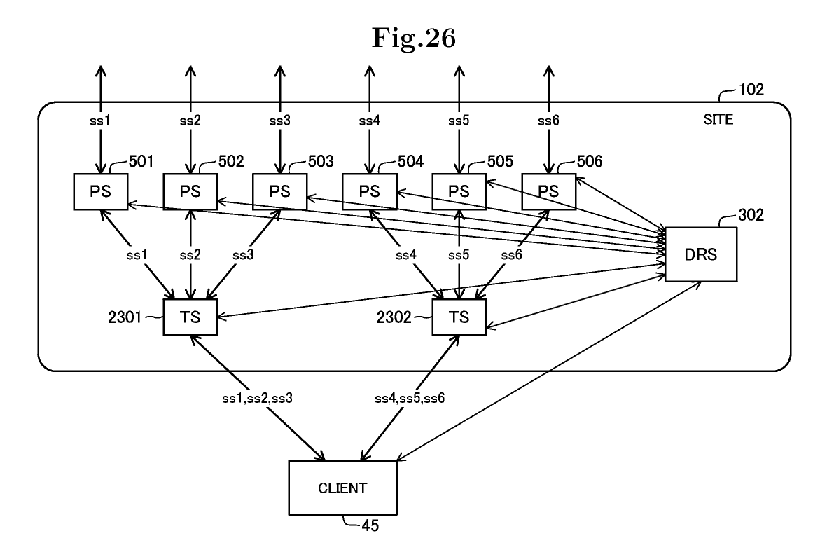

Next, an example of the fourth exemplary embodiment will be described. FIG. 26 is an illustration showing the associated operation among the client 45, the DRS 302, the TSs 2301 and 2302, and the PSs 501 to 506. Here, while the HTTP connection where the client can terminate is “2”, in the transfer network, the TS servers migrate substreams in order to perform parallel transfer under the condition that the total number of substreams is “6”.

Hereinafter, a substream in which the ID is “n” is abbreviated as “ssn”.

If the upper limit number of connections is “2”, when the client requests the DRS 302 designated in the metadata to resolve the F domain, a resolution response is made with the address of the TS 2301 to the ss1, ss2, and ss3, and with the address of the TS 2302 to the ss4, ss5, and ss6. Then, the client sets a persistent connection in each of the TS 2301 and the TS 2302, and transmits HTTP requests including the URI (B-URI) of the blocks belonging to ss1, ss2, ss3, and ss4, ss5, ss6 in a pipelining manner. As such, to the TS 2301, the client transmits HTTP requests including the B-URI corresponding to

block 1, block 2, block 3, block 7, block 8, block 9, . . . respectively, in this order.

Further, to the TS 2302, the client transmits HTTP requests including the B-URI corresponding to

block 4, block 5, block 6, block 10, block 11, block 12, . . . respectively, in this order.

Upon reception, when the TS 2301 first detects B-URI including respective substream IDs of ss1, ss2, and ss3, the TS 2301 transfers a resolution request of each S domain to the DRS 302. Similarly, the TS 2302 transfers a resolution request of each S domain to the DRS 35. These requests are made using the DNS protocol.

Then, it is assumed that the DRS 302 responds to the TS 2301 by assigning the PS 501, the PS 502, and the PS 502 to the resolution requests of the S domains relating to the ss1, ss2, and ss3. Further, it is assumed that the DRS 302 responds to the TS 2302 by assigning the PS 504, the PS 505, and the PS 506 to the resolution request of the S domains relating to the ss4, ss5, and ss6. Then, the TS 2301 sets persistent connections to the PS 501, the PS 502, and the PS 503, and transfers a request including the B-URI corresponding to each S domain onto each of the persistent connections corresponding thereto.

Similarly, the TS 2302 sets persistent connections to the PS 504, the PS 505, and the PS 506, respectively, and transfers a request including the B-URI corresponding to each domain onto each of the persistent connections corresponding thereto. If the PS has data by itself, the PS returns blocks to the TS, while if it does not have data, the PS request the parent site to perform domain resolution of the PS.

It should be noted that in the respective exemplary embodiments described above, the programs may be stored in storing devices or computer-readable recording media. For example, recording media are portable media including flexible disks, optical disks, magneto-optical disks, and semiconductor memories.

While the present invention has been described with reference to the exemplary embodiments described above, the present invention is not limited to the above-described embodiments. The form and details of the present invention can be changed within the scope of the present invention in various manners that can be understood by those skilled in the art.

The present invention is based upon and claims the benefit of priority from Japanese patent application No. 2010-196416, filed on Sep. 2, 2010, the disclosure of which is incorporated herein in its entirety by reference.

### <Supplementary Notes>

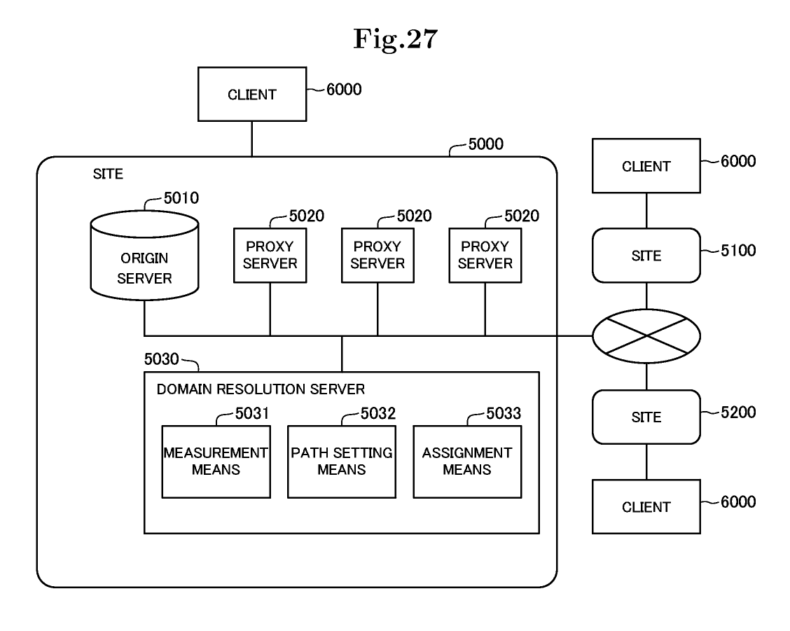

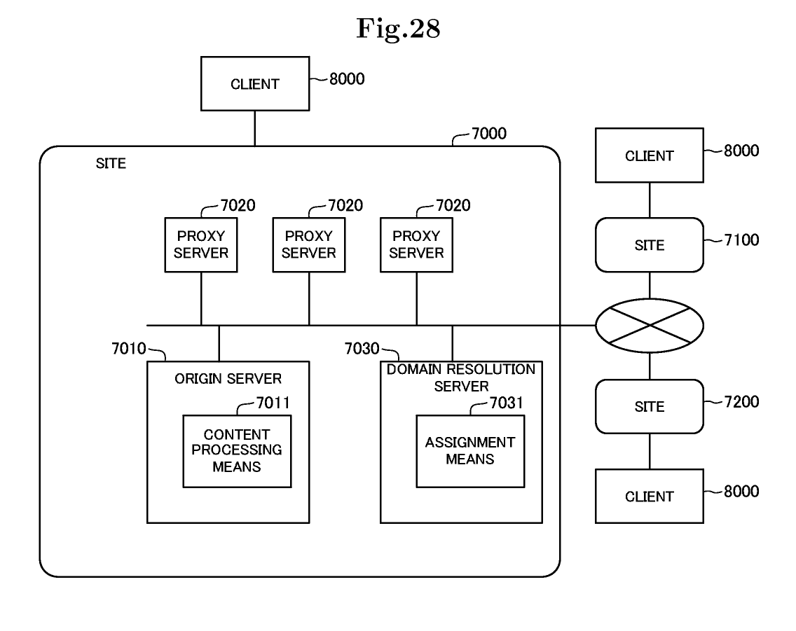

The whole or part of the exemplary embodiments disclosed above can be described as, but not limited to, the following supplementary notes. Hereinafter, the outline of the configuration of a data transfer system according to the present invention will be described with reference to the block diagrams of FIGS. 27 and 28. Further, the outlines of the configurations of a program, an information processing method, and the like according to the present invention will also be described. However, the present invention is not limited to the configurations described below.

### (Supplementary Note 1-1: See FIG. 27)

A data transfer system in which a plurality of sites 5000, 5100, and 5200 are connected over a network, each of the sites including an origin server 5010 in which content is stored, a plurality of proxy servers 5020 that transfer requested content, and a domain resolution server 5030 that resolves one of the proxy servers corresponding to a domain included in an identifier for requesting data by a client 6000, wherein

the domain resolution server 5030 includes:
measurement means 5031 for measuring each of link parameters representing communication states between respective sites;
path setting means 5032 for setting a path for delivering content from the origin server of each of the sites to another one of the sites based on a measurement result; and
assignment means 5033 for assigning a proxy server corresponding to the domain,

on the path set for each of the origin servers, the path setting means 5032 sets a domain resolution server, disposed in an adjacent parent site located upstream of an own site in which an own domain resolution server is disposed, as a parent domain resolution server with respect to the domain resolution server disposed in the own site, and

the assignment means 5033 requests the parent domain resolution server for domain resolution based on the identifier to a proxy server of a data transfer destination, and in accordance with a response from the parent domain resolution server, notifies a proxy server of the own site of a proxy server disposed in the parent site to which a content request should be transferred by the proxy server of the own site, assigns a proxy server to be required from among the proxy servers disposed in the own site in response to a request from the client or a domain resolution server of an adjacent child site located downstream on the path, and notifies the client or the domain resolution server disposed in the child site of the assigned proxy server.

### (Supplementary Note 1-2)

The data transfer system, according to supplementary note 1-1, wherein

the measurement means measures a communication state between domain resolution servers disposed in the respective sites, in which a transmission direction and a reception direction of data between the domain resolution servers are distinguished, as a link parameter representing the communication state between the sites.

### (Supplementary Note 1-3)

The data transfer system, according to supplementary note 1-2, wherein

as the link parameter, the measurement means measures a round trip time between the domain resolution servers respectively disposed in the respective sites, and

the path setting means sets a path in which a maximum value of the round trip times between the respective sites on the respective paths is a minimum.

### (Supplementary Note 1-4)

The data transfer system, according to supplementary note 1-2, wherein

as the link parameter, the measurement means measures a round trip time between the domain resolution servers respectively disposed in the respective sites, and

the path setting means sets a path in which the total sum of the round trip times between the respective sites on the respective paths is a minimum.

### (Supplementary Note 1-5)

The data transfer system, according to any of supplementary notes 1-2 to 1-4, wherein

the measurement means of the domain resolution server measures, with respect to another domain resolution server, the link parameter between the own domain resolution server and the other domain resolution server, and at the time of measurement, requests the other domain resolution server for a measurement result having been measured by the other domain resolution server and acquires the measurement result.

### (Supplementary Note 1-6)

The data transfer system, according to any of supplementary notes 1-1 to 1-5, wherein

the measurement means and the path setting means included in the domain resolution server operate with predetermined timing so as to set the path and the parent domain resolution server.

### (Supplementary Note 1-7)

The data transfer system, according to any of supplementary notes 1-1 to 1-6, wherein

the path setting means included in the domain resolution server of each of the sites determines a path for delivering content stored in the origin server of the own site, determines the parent domain resolution server, and notifies another domain resolution server of the parent domain resolution server, and the other domain resolution server sets the parent domain resolution server based on the notification.

### (Supplementary Note 1-8)

A domain resolution server in a case of a plurality of sites being connected over a network, each of the sites including an origin server in which content is stored, a plurality of proxy servers that transfer requested content, and a domain resolution server that resolves one of the proxy servers corresponding to a domain included in an identifier for requesting data by a client, the domain resolution server comprises:

measurement means for measuring each of link parameters representing communication states between respective sites;

path setting means for setting a path for delivering content from the origin server of each of the sites to another one of the sites based on a measurement result; and

assignment means for assigning a proxy server corresponding to the domain, wherein

on the path set for each of the origin servers, the path setting means sets a domain resolution server, disposed in an adjacent parent site located upstream of an own site in which an own domain resolution server is disposed, as a parent domain resolution server with respect to the domain resolution server disposed in the own site, and

the assignment means requests the parent domain resolution server for domain resolution based on the identifier to a proxy server of a data transfer destination, and in accordance with a response from the parent domain resolution server, notifies a proxy server of the own site of a proxy server disposed in the parent site to which a content request should be transferred by the proxy server of the own site, assigns a proxy server to be required from among the proxy servers disposed in the own site in response to a request from the client or a domain resolution server of an adjacent child site located downstream on the path, and notifies the client or the domain resolution server disposed in the child site of the assigned proxy server.

### (Supplementary Note 1-9)

The domain resolution server, according to supplementary note 1-8, wherein

the measurement means measures a communication state between domain resolution servers disposed in the respective sites, in which a transmission direction and a reception direction of data between the domain resolution servers are distinguished, as a link parameter representing the communication state between the sites.

### (Supplementary Note 1-10)

A program to be installed in a domain resolution server in a case of a plurality of sites being connected over a network, each of the sites including an origin server in which content is accumulated, a plurality of proxy servers that transfer requested content, and the domain resolution server that resolves one of the proxy servers corresponding to a domain included in an identifier for requesting data by a client, the program realizing, in the domain resolution server:

measurement means for measuring each of link parameters representing communication states between respective sites;

path setting means for setting a path for delivering content from the origin server of each of the sites to another one of the sites based on a measurement result; and

assignment means for assigning a proxy server corresponding to the domain, wherein

on the path set for each of the origin servers, the path setting means sets a domain resolution server, disposed in an adjacent parent site located upstream of an own site in which an own domain resolution server is disposed, as a parent domain resolution server with respect to the domain resolution server disposed in the own site, and

the assignment means requests the parent domain resolution server for domain resolution based on the identifier to a proxy server of a data transfer destination, and in accordance with a response from the parent domain resolution server, notifies a proxy server of the own site of a proxy server disposed in the parent site to which a content request should be transferred by the proxy server of the own site, assigns a proxy server to be required from among the proxy servers disposed in the own site in response to a request from the client or a domain resolution server of an adjacent child site located downstream on the path, and notifies the client or the domain resolution server disposed in the child site of the assigned proxy server.

### (Supplementary Note 1-11)

The program, according to supplementary note 1-10, wherein

the measurement means measures a communication state between domain resolution servers disposed in the respective sites, in which a transmission direction and a reception direction of data between the domain resolution servers are distinguished, as a link parameter representing the communication state between the sites.

### (Supplementary Note 1-12)

A data transfer method in a data transfer system in which a plurality of sites are connected over a network, each of the sites including an origin server in which content is accumulated, a plurality of proxy servers that transfer requested content, and a domain resolution server that resolves one of the proxy servers corresponding to a domain included in an identifier for requesting data by a client, the method comprising

by the domain resolution server, measuring each of link parameters representing communication states between respective sites, setting a path for delivering content from the origin server of each of the sites to another one of the sites based on a measurement result, and assigning a proxy server corresponding to the domain, wherein

the setting the path includes, on the path set for each of the origin servers, setting a domain resolution server, disposed in an adjacent parent site located upstream of an own site in which an own domain resolution server is disposed, as a parent domain resolution server with respect to the domain resolution server disposed in the own site, and

the assigning includes requesting the parent domain resolution server for domain resolution based on the identifier to a proxy server of a data transfer destination, and in accordance with a response from the parent domain resolution server, notifying a proxy server of the own site of a proxy server disposed in the parent site to which a content request should be transferred by the proxy server of the own site, assigning a proxy server to be required from among the proxy servers disposed in the own site in response to a request from the client or a domain resolution server of an adjacent child site located downstream on the path, and notifying the client or the domain resolution server disposed in the child site of the assigned proxy server.

### (Supplementary Note 1-13)

The data transfer method, according to supplementary note 1-12, wherein

the measuring the link parameter includes measuring a communication state between domain resolution servers disposed in the respective sites, in which a transmission direction and a reception direction of data between the domain resolution servers are distinguished, as a link parameter representing the communication state between the sites.

### (Supplementary Note 2-1: See FIG. 28)

A data transfer system in which a plurality of sites 7000, 7100, and 7200 are connected over a network, each of the sites including an origin server 7010 in which content is stored, a plurality of proxy servers 7020 that transfer requested content, and a domain resolution server 7030 that that resolves one of the proxy servers corresponding to a domain included in an identifier for requesting data by a client 8000, wherein

the origin server 7010 has content in block units formed by dividing the content, and includes content processing means 7011 for providing each of the blocks with an identifier including a domain which identifies each substream including one or a plurality of the blocks,

the domain resolution server 7030 includes assignment means 7031 for determining a proxy server which should be assigned for each domain identifying the substream, and

when the assignment means 7031 requests a proxy server of an adjacent parent site located upstream, on a path from a site in which the origin server is disposed to an edge site accessed by the client, to resolve a domain of one substream from the proxy server of an own site in which an own domain resolution server is disposed, the assignment means makes a domain resolution request to a domain resolution server of the parent site for assigning a proxy server, disposed in the parent site, to each of all substreams constituting content which is a source of the one substream.

### (Supplementary Note 2-2)

The data transfer system, according to supplementary note 2-1, wherein

the content processing means included in the origin server provides each of the blocks with an identification number corresponding to sequence of reproducing the content which is a source of each of the blocks, and provides blocks, having the same reminder value calculated by dividing an identification number of divided data by the total number of the substreams, with an identifier including a domain of the same substream.

### (Supplementary Note 2-3)

The data transfer system, according to supplementary note 2-1 or 2-2, wherein

the content processing means included in the origin server provides each of the blocks with the identifier including the total number of the substreams.

### (Supplementary Note 2-4)

The data transfer system, according to any of supplementary notes 2-1 to 2-3, wherein

the data transfer system includes a relay server that transfers the content between the client and the proxy server, in an edge site accessed by the client, and

the assignment means of the domain resolution server assigns relay servers of the number within an upper limit of the number of connections that the client is able to set.

### (Supplementary Note 2-5)

An origin server in a data transfer system in which a plurality of sites are connected over a network, each of the sites including the origin server in which content is stored, a plurality of proxy servers that transfer requested content, and a domain resolution server that resolves one of the proxy servers corresponding to a domain included in an identifier for requesting data by a client,

the origin server having content in block units formed by dividing the content, and comprising content processing means for providing each of the blocks with an identifier including a domain which identifies each substream including one or a plurality of the blocks, wherein

the content processing means provides each of the blocks with an identification number corresponding to sequence of reproducing the content which is a source of each of the blocks, and provides blocks, having the same reminder value calculated by dividing an identification number of divided data by the total number of the substreams, with an identifier including a domain corresponding to the same substream.

### (Supplementary Note 2-6)

The origin server, according to supplementary note 2-5, wherein

the content processing means provides each of the blocks with the identifier including the total number of the substreams.

### (Supplementary Note 2-7)

A program to be installed in an origin server in a data transfer system in which a plurality of sites are connected over a network, each of the sites including an origin server in which content is stored, a plurality of proxy servers that transfer requested content, and a domain resolution server that resolves one of the proxy servers corresponding to a domain included in an identifier for requesting data by a client, wherein

the program causes the origin server to have content in block units formed by dividing the content, and realizes, in the origin server, content processing means for providing each of the blocks with an identifier including a domain which identifies each substream including one or a plurality of the blocks, and

the content processing means provides each of the blocks with an identification number corresponding to sequence of reproducing the content which is a source of each of the blocks, and provides blocks, having the same reminder value calculated by dividing an identification number of divided data by the total number of the substreams, with an identifier including a domain corresponding to the same substream.

### (Supplementary Note 2-8)

A domain resolution server in a data transfer system in which a plurality of sites are connected over a network, each of the sites including an origin server in which content is stored, a plurality of proxy servers that transfer requested content, and the domain resolution server that resolves one of the proxy servers corresponding to a domain included in an identifier for requesting data by a client, wherein

in the origin server, each of blocks formed by dividing content is provided with an identifier including a domain which identifies each substream including one or a plurality of the blocks,

the domain resolution server includes assignment means for determining a proxy server which should be assigned for each domain identifying the substream, and

when the assignment means requests a proxy server of an adjacent parent site located upstream, on a path from a site in which the origin server is disposed to an edge site accessed by the client, to resolve a domain of one substream from the proxy server of an own site in which an own domain resolution server is disposed, the assignment means makes a domain resolution request to a domain resolution server of the parent site for assigning a proxy server disposed in the parent site to each of all substreams constituting content which is a source of the one substream.

### (Supplementary Note 2-9)

A program to be incorporated in a domain resolution server in a data transfer system in which a plurality of sites are connected over a network, each of the sites including an origin server in which content is stored, a plurality of proxy servers that transfer requested content, and the domain resolution server that resolves one of the proxy servers corresponding to a domain included in an identifier for requesting data by a client, wherein

in the origin server, each of blocks formed by dividing content is provided with an identifier including a domain which identifies each substream including one or a plurality of the blocks,

the program realizes, in the domain resolution server, assignment means for determining a proxy server which should be assigned for each domain identifying the substream, and

when the assignment means requests a proxy server of an adjacent parent site located upstream, on a path from a site in which the origin server is disposed to an edge site accessed by the client, to resolve a domain of one substream from the proxy server of an own site in which an own domain resolution server is disposed, the assignment means makes a domain resolution request to a domain resolution server of the parent site for assigning a proxy server disposed in the parent site to each of all substreams constituting content which is a source of the one substream.

### (Supplementary Note 2-10)

A data transfer method in a data transfer system in which a plurality of sites are connected over a network, each of the sites including an origin server in which content is stored, a plurality of proxy servers that transfer requested content, and a domain resolution server that resolves one of the proxy servers corresponding to a domain included in an identifier for requesting data by a client, the method comprising:

by the origin server having content in block units formed by dividing the content, providing each of the blocks with an identifier including a domain which identifies each substream including one or a plurality of the blocks;

by the domain resolution server, determining a proxy server which should be assigned for each domain identifying the substream; and

by the domain resolution server, at the time of assigning the proxy server, when requesting a proxy server of an adjacent parent site located upstream, on a path from a site in which the origin server is disposed to an edge site accessed by the client, to resolve a domain of one substream from the proxy server of an own site in which an own domain resolution server is disposed, making a domain resolution request to a domain resolution server of the parent site for assigning a proxy server disposed in the parent site to each of all substreams constituting content which is a source of the one substream.

### (Supplementary Note 2-11)

The data transfer method, according to supplementary note 2-10, wherein

the providing each of the blocks with the identifier by the origin server includes providing each of the blocks with an identification number corresponding to sequence of reproducing the content which is a source of each of the blocks, and providing blocks, having the same reminder value calculated by dividing an identification number of divided data by the total number of the substreams, with an identifier including a domain of the same substream.

### INDUSTRIAL APPLICABILITY

As described above, the present invention is applicable to purposes such as a delivery service of content data and a delivery service of application data, from a plurality of server sites which are distributedly disposed geographically on the Internet configured of a plurality of ASs which are network operation units, or from a data center. Further, the present invention is usable not only for distribution of content from an origin site to an edge site, but also for application delivery in which a result processed by an application of the OGS is transferred to a web client of an end user via one or more relay sites.

### DESCRIPTION OF REFERENCE NUMERALS

101˜104 site
202, 204 origin server (OGS)
12 transmission device
13 reception device
10 processing device
1001 issuance processing section
1002 web server processing section
1003 client processing section
7 storing device
71 block storing section
72 metadata storing section
73 geographic data storing section
301˜304 domain resolution server (DRS)
14 transmission device
15 reception device
8 data processing device
81 PS assignment section
82 parent DRS determination section
83 distribution tree calculation section
9 storing section
91 local PS storing section
92 parent PS cache section
93 parent DRS storing section
94 RTT matrix storing section
95 RTT statistics storing section
96 distribution tree storing section
41˜45 client
21 output device
22 transmission device
23 reception device
24 data processing device
25 input device
2401 display processing section
2402 reproduction processing section
2403 background processing section
11 storing device
1101 block storing section
1102 metadata storing section
501˜512 proxy server (PS)
18 subnetwork
19 multilayer switch
20 edge router
2301, 2302 transformation server (TS)

What is claimed is:

1. A data transfer system in which a plurality of sites are connected over a network, each of the sites including an origin server in which content is stored, a plurality of proxy servers that transfer requested content, and a domain resolution server that resolves one of the proxy servers corresponding to a domain included in an identifier for requesting data by a client, wherein
the domain resolution server includes:
a measurement unit that measures each of link parameters representing communication states between respective sites;
a path setting unit that sets a path for delivering content from the origin server of each of the sites to another one of the sites based on a measurement result; and
an assignment unit that assigns a proxy server corresponding to the domain,
on the path set for each of the origin servers, the path setting unit sets a domain resolution server, disposed in an adjacent parent site located upstream of an own site in which an own domain resolution server is disposed, as a parent domain resolution server with respect to the domain resolution server disposed in the own site, and
the assignment unit requests the parent domain resolution server for domain resolution based on the identifier to a proxy server of a data transfer destination, and in accordance with a response from the parent domain resolution server, notifies a proxy server of the own site of a proxy server disposed in the parent site to which a content request should be transferred by the proxy server of the own site, assigns a proxy server to be required from among the proxy servers disposed in the own site in response to a request from the client or a domain resolution server of an adjacent child site located downstream on the path, and notifies the client or the domain resolution server disposed in the child site of the assigned proxy server.

2. The data transfer system, according to claim 1, wherein
the measurement unit measures a communication state between domain resolution servers disposed in the respective sites, in which a transmission direction and a reception direction of data between the domain resolution servers are distinguished, as a link parameter representing the communication state between the sites.

3. The data transfer system, according to claim 2, wherein
as the link parameter, the measurement unit measures a round trip time between the domain resolution servers respectively disposed in the respective sites, and
the path setting unit sets a path in which a maximum value of the round trip times between the respective sites on the respective paths is a minimum.

4. The data transfer system, according to claim 2, wherein
as the link parameter, the measurement unit measures a round trip time between the domain resolution servers respectively disposed in the respective sites, and
the path setting unit sets a path in which the total sum of the round trip times between the respective sites on the respective paths is a minimum.

5. The data transfer system, according to claim 2, wherein
the measurement unit of the domain resolution server measures, with respect to another domain resolution server, the link parameter between the own domain resolution server and the other domain resolution server, and at the time of measurement, requests the other domain resolution server for a measurement result having been measured by the other domain resolution server and acquires the measurement result.

6. The data transfer system, according to claim 1, wherein
the measurement unit and the path setting unit included in the domain resolution server operate with predetermined timing so as to set the path and the parent domain resolution server.

7. The data transfer system, according to claim 1, wherein
the path setting unit included in the domain resolution server of each of the sites determines a path for delivering content stored in the origin server of the own site, determines the parent domain resolution server, and notifies another domain resolution server of the parent domain resolution server, and the other domain resolution server sets the parent domain resolution server based on the notification.

8. A domain resolution server in a case of a plurality of sites being connected over a network, each of the sites including an origin server in which content is stored, a plurality of proxy servers that transfer requested content, and a domain resolution server that resolves one of the proxy servers corresponding to a domain included in an identifier for requesting data by a client, the domain resolution server comprises:
a measurement unit that measures each of link parameters representing communication states between respective sites;
a path setting unit that sets a path for delivering content from the origin server of each of the sites to another one of the sites based on a measurement result; and
an assignment unit that assigns a proxy server corresponding to the domain, wherein
on the path set for each of the origin servers, the path setting unit sets a domain resolution server, disposed in an adjacent parent site located upstream of an own site in which an own domain resolution server is disposed, as a parent domain resolution server with respect to the domain resolution server disposed in the own site, and
the assignment unit requests the parent domain resolution server for domain resolution based on the identifier to a proxy server of a data transfer destination, and in accordance with a response from the parent domain resolution server, notifies a proxy server of the own site of a proxy server disposed in the parent site to which a content request should be transferred by the proxy server of the own site, assigns a proxy server to be required from among the proxy servers disposed in the own site in response to a request from the client or a domain resolution server of an adjacent child site located downstream on the path, and notifies the client or the domain resolution server disposed in the child site of the assigned proxy server.

9. The domain resolution server, according to claim 8, wherein
the measurement unit measures a communication state between domain resolution servers disposed in the respective sites, in which a transmission direction and a reception direction of data between the domain resolution servers are distinguished, as a link parameter representing the communication state between the sites.

10. A non-transitory computer-readable storage medium storing a program to be installed in a domain resolution server in a case of a plurality of sites being connected over a network, each of the sites including an origin server in which content is accumulated, a plurality of proxy servers that transfer requested content, and the domain resolution server that resolves one of the proxy servers corresponding to a domain included in an identifier for requesting data by a client, the program realizing, in the domain resolution server:
a measurement unit that measures each of link parameters representing communication states between respective sites;
a path setting unit that sets a path for delivering content from the origin server of each of the sites to another one of the sites based on a measurement result; and
an assignment unit that assigns a proxy server corresponding to the domain, wherein
on the path set for each of the origin servers, the path setting unit sets a domain resolution server, disposed in an adjacent parent site located upstream of an own site in which an own domain resolution server is disposed, as a parent domain resolution server with respect to the domain resolution server disposed in the own site, and
the assignment unit requests the parent domain resolution server for domain resolution based on the identifier to a proxy server of a data transfer destination, and in accordance with a response from the parent domain resolution server, notifies a proxy server of the own site of a proxy server disposed in the parent site to which a content request should be transferred by the proxy server of the own site, assigns a proxy server to be required from among the proxy servers disposed in the own site in response to a request from the client or a domain resolution server of an adjacent child site located downstream on the path, and notifies the client or the domain resolution server disposed in the child site of the assigned proxy server.

11. The non-transitory computer-readable storage medium storing the program, according to claim 10, wherein
the measurement unit measures a communication state between domain resolution servers disposed in the respective sites, in which a transmission direction and a reception direction of data between the domain resolution servers are distinguished, as a link parameter representing the communication state between the sites.

12. A data transfer method in a data transfer system in which a plurality of sites are connected over a network, each of the sites including an origin server in which content is accumulated, a plurality of proxy servers that transfer requested content, and a domain resolution server that resolves one of the proxy servers corresponding to a domain included in an identifier for requesting data by a client, the method comprising
by the domain resolution server, measuring each of link parameters representing communication states between respective sites, setting a path for delivering content from the origin server of each of the sites to another one of the sites based on a measurement result, and assigning a proxy server corresponding to the domain, wherein
the setting the path includes, on the path set for each of the origin servers, setting a domain resolution server, disposed in an adjacent parent site located upstream of an own site in which an own domain resolution server is disposed, as a parent domain resolution server with respect to the domain resolution server disposed in the own site, and
the assigning includes requesting the parent domain resolution server for domain resolution based on the identifier to a proxy server of a data transfer destination, and in accordance with a response from the parent domain resolution server, notifying a proxy server of the own site of a proxy server disposed in the parent site to which a content request should be transferred by the proxy server of the own site, assigning a proxy server to be required from among the proxy servers disposed in the own site in response to a request from the client or a domain resolution server of an adjacent child site located downstream on the path, and notifying the client or the domain resolution server disposed in the child site of the assigned proxy server.

13. The data transfer method, according to claim 12, wherein
the measuring the link parameter includes measuring a communication state between domain resolution servers disposed in the respective sites, in which a transmission direction and a reception direction of data between the domain resolution servers are distinguished, as a link parameter representing the communication state between the sites.
